(19) United States
(12) Patent Application Publication
(10) Pub. No.: US 2016/0127460 A1
(43) Pub. Date: May 5, 2016

(54) MULTI-HOP WIRELESS PEER-TO-PEER DISCOVERY PROTOCOL

(71) Applicant: Qualcomm Technologies Inc., San Diego, CA (US)

(72) Inventors: Gang Ding, San Diego, CA (US); Richard Oliver Farley, San Diego, CA (US); Md Sazzadur Rahman, San Diego, CA (US)

(21) Appl. No.: 14/531,329

(22) Filed: Nov. 3, 2014

(51) Int. Cl. H04L 29/08; H04W 4/06; H04W 8/00

(52) U.S. Cl. CPC H04L 67/107; H04W 8/005; H04W 4/06

(57) ABSTRACT

A method is disclosed for discovering communication devices. The method includes broadcasting, with a first communication device, a message that can be detected by one-hop neighbors. The first communication device listens for data indicating that it has at least one two-hop neighbor, and constructs and stores a list of its one-hop and two-hop neighbors. In addition, the method may also include selecting a subset of the set of one-hop neighbors such that all of the two-hop neighbors of the first communication device can be reached by the first communication device through the subset of one-hop neighbors. Then the selected subset is stored on a list on the first communication device. Next, the first communication device broadcasts to one-hop neighbors in the selected subset, the data indicating that a one-hop neighbor is part of the selected subset. The method also allows the discovery of multi-hop neighbors by utilizing the selected subset.

### TECHNICAL FIELD

The present invention relates to communication devices. In particular, but not by way of limitation, the present invention relates to a peer-to-peer discovery protocol that enables communication devices to discover each other.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

As such, in the near future, increasing development in IoT technologies will lead to numerous IoT devices surrounding a user at home, in vehicles, at work, and many other locations. However, despite the fact that IoT capable devices can provide substantial real-time information about the environment surrounding a user (e.g., likes, choices, habits, device conditions and usage patterns, etc.), it can be relatively difficult for different IoT devices to determine if they are in close physical proximity to each other and to discover each other in order to create a network.

An additional consideration of certain IoT devices is that they may be limited or constrained in their available power, mobility, wireless transmission range, processing capability, and/or memory. Certain devices that perform specific, limited functions are often designed to conserve resources such as power and data transmission.

In addition to IoT devices, communication devices such as smartphones, netbooks, gaming devices, PDAs, desktop computers, and laptop computers are now ubiquitous. And the capabilities of these communication devices have developed to a level that enables these communication devices to intercommunicate in a wireless, peer-to-peer manner.

For example, peer-to-peer communication is now used in connection with a variety of applications including gaming (e.g., multi-player gaming), social networking (e.g., users may exchange messages), groupware applications (e.g., information may be synchronized and shared among ad-hoc groups without an external network), proximity based services (information may be broadcast to communication devices when within close proximity), and media entertainment applications (e.g., remote control and game control).

As the capabilities of peer-to-peer connectivity has increased, it has become apparent that peer-to-peer networks can have beneficial application in IoT devices as well as traditional wireless communication devices. That is, constrained IoT devices within a home can connect with other constrained capability devices, or with devices that are constrained in some aspects but not others, or with robust mobile devices such as smartphones, or with robust computer systems or home automation hubs, or with all of these devices at the same time using peer-to-peer networks.

Various protocols currently exist for allowing connected devices, including both mobile devices such as phones and stationary devices such as IoT capable home devices, to discover other devices so that multiple devices can join together in a peer-to-peer network. However, the systems and methods that currently exist can be improved in areas such as conservation of power data transmission, and other resources, as well as in their capability of discovering remote devices.

As a consequence, the existing peer-to-peer wireless discovery protocols are often less than desirable and will almost certainly be unsatisfactory in the future.

### SUMMARY

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

Aspects of the invention may be characterized as a method for discovering neighbors of communication devices, wherein neighbors are also communication devices. The method may include broadcasting, with a first communication device, a message that can be detected by one-hop neighbors. One-hop neighbors can be neighbors within a physical wireless transmission range of each other. The first communication device listens for messages from other one-hop neighbors that contain data indicating that the first communication device has at least one two-hop neighbor. Two-hop neighbors can be neighbors that share a common one-hop neighbor. Then a set of all one-hop neighbors is constructed and stored. Additionally, a set of all two-hop neighbors is constructed from the data received from all one-hop neighbors. In addition, the method may also include selecting a subset of the set of one-hop neighbors such that all of the two-hop neighbors of the first communication device can be reached by the first communication device through the subset of one-hop neighbors. Then the subset is stored on a list on the first communication device. Next, the first communication device broadcasts to one-hop neighbors in the subset, the data indicating that a particular one-hop neighbor is part of the subset. The method may also include providing, in response to a request from a particular two-hop neighbor of the first communication device, the set of all one-hop neighbors of the first communication device, such that any one-hop neighbor of the first communication device is discoverable as a three-hop neighbor of the particular two-hop neighbor.

Another aspect may be characterized as a system for discovering neighbors of communication devices, wherein neighbors are also communication devices. In the system, one-hop neighbors can be neighbors within physical wireless transmission range of each other, and wherein n-hop neighbors can be neighbors linked by (n−1) one-hop neighbors situated between the n-hop neighbors. The system may include a plurality of communication devices in a peer-to-peer network arranged such that all devices are within n+1 hops from each other, wherein n+1 is the largest number of hops between any two of the communication devices. The system may include a first communication device within the plurality of communications devices, at least one one-hop neighbor of the first communication device, and at least one two-hop neighbor of the first communication device. At least two of the devices may be three hops away from each other. Each device may run a discovery protocol that is asynchronous with at least one other of the communication devices that is running a discovery protocol. Additionally, each of the communication devices may comprise a list storage component for storing data about its neighbors and an advertising component that broadcasts the stored data about its neighbors that allows a device that is n-hops away from the first communication device to discover a device that is n+1 hops away.

Yet another aspect may be characterized as non-transitory, tangible computer readable storage medium encoded with processor readable instructions to perform a method for discovering neighbors of communication devices, wherein neighbors are also communication devices. The method can include broadcasting, with a first communication device, a message that can be detected by one-hop neighbors. The one-hop neighbors can be neighbors within a physical wireless transmission range of each other. The first communication device listens for messages from other one-hop neighbors that contain data indicating that the first communication device has at least one two-hop neighbor. Two-hop neighbors can be neighbors that share a common one-hop neighbor. Then, a set of all one-hop neighbors is constructed and stored. Additionally, a set of all two-hop neighbors is constructed from the data received from all one-hop neighbors. In addition, the method may also include selecting a subset of the set of one-hop neighbors such that all of the two-hop neighbors of the first communication device can be reached by the first communication device through the subset of one-hop neighbors. Then the subset is stored on a list on the first communication device. Next the first communication device broadcasts to one-hop neighbors in the subset, the data indicating that a one-hop neighbor is part of the subset. The method may also include providing, in response to a request from a particular two-hop neighbor of the first communication device, the set of all one-hop neighbors of the first communication device, such that any one-hop neighbor of the first communication device is discoverable as a three-hop neighbor of the particular two hop neighbor.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings in which like or similar elements are designated with identical reference numerals throughout the several views, and wherein:

FIG. 1 is a diagram depicting an environment in accordance with embodiments of the present disclosure, including several household devices configured to perform aspects of the disclosure.

FIG. 2 is a functional block diagram of several constrained devices, a gateway device, and a mobile device configured to discover each other according to aspects of the present disclosure.

FIG. 2A is a functional block diagram depicting the peer devices shown in FIG. 2 according to an aspect of the disclosure.

FIG. 3 is a functional block diagram of a peer device that can be configured to perform aspects of the present disclosure.

FIG. 4 is a functional block diagram of an alternative peer device that can be configured to perform aspects of the present disclosure.

FIG. 5 is a flowchart depicting a method by which parameters corresponding to states of a discovery protocol may be derived according to an aspect of the disclosure.

FIG. 6 is a flowchart that depicts a method of a discovery protocol that a peer device may perform according to aspects of the present disclosure.

FIG. 7 is a diagram depicting two peer devices running through an asynchronous discovery protocol according to an aspect of the disclosure.

FIG. 8 is a diagram depicting the asynchronous discovery protocol of FIG. 7 and exemplary parameters that correspond with various states of the discovery protocol according to an aspect of the disclosure.

FIG. 9 is a diagram depicting an exemplary network of peer devices within one and two hops of each other according to an aspect of the disclosure.

FIG. 10 is a set of two tables listing exemplary data and designations of data of the peers depicted in FIG. 9 according to an aspect of the disclosure.

FIG. 11 is the diagram as shown in FIG. 9 specifically highlighting a particular set of peer devices according to an aspect of the disclosure.

FIG. 12 is a table listing further exemplary data and designations of data of the peers depicted in FIGS. 9 and 11 according to an aspect of the disclosure.

FIG. 13 is an expanded diagram of FIG. 9 further depicting three and four-hop neighbors in a peer network and exemplary data according to an aspect of the disclosure.

FIG. 14 is a set of tables listing exemplary data in connection with FIG. 13 according to an aspect of the disclosure.

FIG. 15 is a diagram depicting asynchronous multi-hop discovery according to an aspect of the present disclosure.

FIG. 16 is a flowchart depicting a method that may be traversed by the components in FIG. 2A, according to an aspect of the disclosure.

### DETAILED DESCRIPTION

Various aspects are disclosed in the following description and related drawings to show specific examples relating to exemplary embodiments of asynchronous multi-hop discovery protocols between Internet of Things (IoT) devices, computing devices, and mobile communications devices. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. Such devices may also be referred to a “connected device” for the purposes of this disclosure. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, thermometers, humidity sensors, soil sensors, security cameras, motion detection lights, wearable devices etc., so long as the devices are equipped with an addressable communications interface for communicating with the IoT network. IoT devices and connected devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that have not typically had Internet-connectivity in the past (e.g., dishwashers, etc.). All previously described devices may also be referred to as “connected devices,” such that the term “connected device” can encompass the range from the simplest IoT devices to the most robust legacy Internet accessible devices.

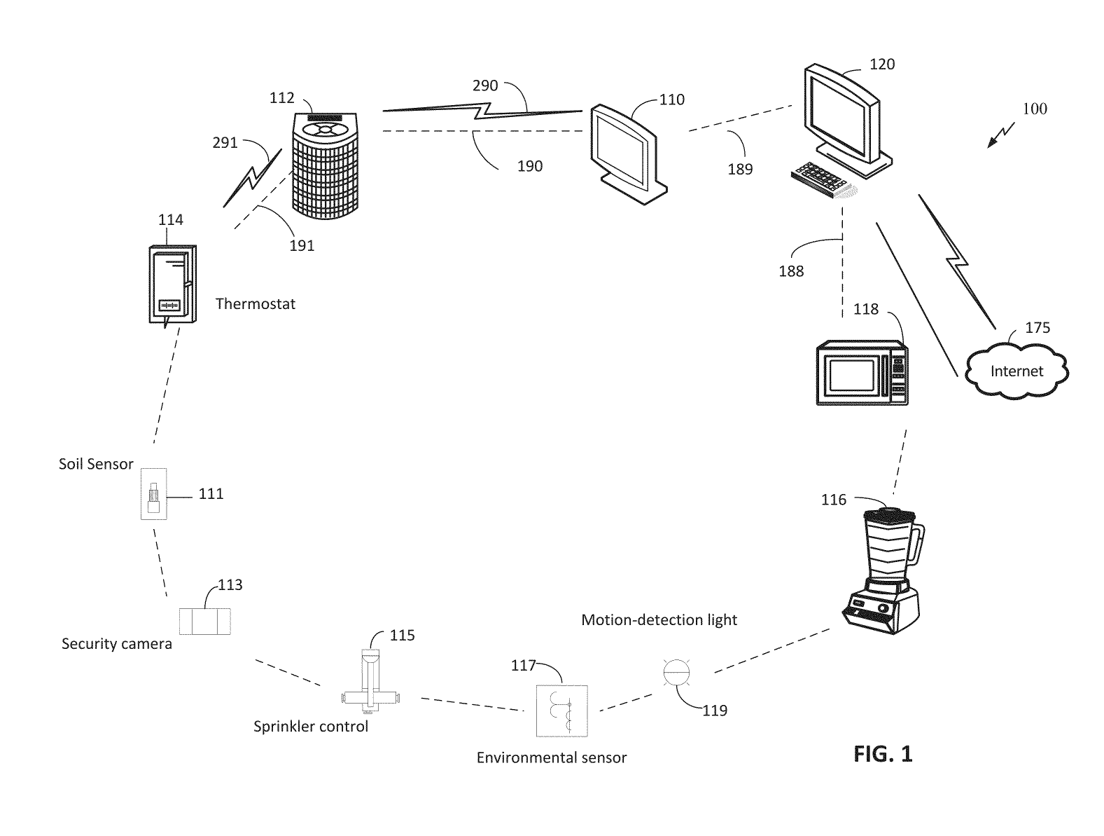

FIG. 1 illustrates a high-level system architecture of a wireless communications system 100 in accordance with an aspect of the disclosure. The wireless communication system 100 can exist in an environment such as a household with multiple IoT devices. In the diagram, the wireless communication system 100 contains a desktop computer 120 which is connected to the Internet 175 via a wired or wireless connection. The wireless communications system 100 contains a plurality of IoT devices that are traditionally connected to AC power sources, which include a television 110, an outdoor air conditioning unit 112, a thermostat 114, a blender 116, and a microwave 118. The wireless communication system 100 also contains a plurality of IoT devices that are constrained in some aspect of their capability.

The capabilities of various IoT devices fall on a wide spectrum. “Constraints” on devices, as referred to in this disclosure, include capabilities for mobility, power consumption, processing, memory, data transfer, and wireless transmission. Devices may be referred to as “more constrained” when they have fewer capabilities or less capacity regarding the functions previously described in relation to another device. Mobility itself can be both a constraining or non-constraining feature. For example, a device may have less wireless transmission capability because it is stationary, but it also may have access to more power, such as AC power, because it is stationary. A few examples illustrate the range of capabilities of various devices. A connected device such as a soil pH sensor may be constrained in all possible aspects; it is mostly stationary, may run on solar power, and will have limited wireless transmission, processing, and memory capabilities. A connected heart rate monitor may be mobile and wearable, but it may run on a battery, and may also have limited wireless transmission, processing, and memory capability. A connected appliance such as a refrigerator may be connected to AC power, but it may also have limited wireless transmission, processing, and memory capabilities. A connected smart watch may be mobile, wearable, and run on a battery, but may have quite robust wireless transmission, processing, and memory capability. In general, for purposes of this disclosure, mobile communications devices and legacy Internet-accessible devices will not be referred to as “constrained,” even though they may be mobile and/or battery-operated.

Referring still to FIG. 1, various constrained devices are depicted within the wireless communication network 100, such as a soil sensor 111, a security camera 113, a sprinkler control 115, an environmental sensor 117 (e.g., for sensing temperature, humidity, barometric pressure, air quality, etc.), and motion-detection light 119. For clarity, devices that may not be readily recognized by their drawings have been labeled with their descriptions. The environment depicted illustrates how various devices within and outside a household may be arranged and connected to each other. Dashed lines such as those depicted by lines 188, 189, 190, and 191 illustrate a wireless radio discovery relationship between devices. In particular, one dashed line, such as the dashed line 190 between the television 110 and the air conditioning unit 112 represents a “one-hop” discovery relationship. “One-hop” refers to the discovery capability between two devices that is possible because they are in physical proximity to each other. That is, they are within the physical range of transmission of their own wireless radio equipment. Note that being in a one-hop discovery relationship does not necessarily mean that devices have formed an actual wireless connection, such as through some kind of interface that allows them to regularly exchange information. Such a wireless connection is distinct from a one-hop discovery relationship. An actual wireless connection (e.g., a persistent wireless connection that enables ongoing exchange of data packets) is represented by, for example, the depiction of the lightning bolt 290 between the television 110 and the air conditioning unit 112, and by the lightning bolt 291 between the air conditioning unit 112 and the thermostat 114. Thus, a one-hop discovery relationship may exist simultaneously with an actual wireless connection. Alternatively, a one-hop connection may exist without an actual wireless connection, and an actual wireless connection may exist without a one-hop connection.

For the purposes of this disclosure, devices that may discover each other through any wireless communication protocol within the physical range of the device are described as having a one-hop relationship. That is, they are in physical wireless transmission range of each other. Alternatively, they may be described as one-hop neighbors. In the example depicted in FIG. 1, devices having one-hop relationships to each other are depicted through a single dashed line such as 190. As illustrated, computer 120 has a one-hop relationship 189 to television 110 and has a different one-hop relationship 188 to microwave 118.

In some embodiments of this disclosure, peer IoT devices can utilize a peer-to-peer discovery protocol to discover peers that are more than one hop away. For example, computer 120 is two hops away from air conditioner 112, with the first hop being one-hop relationship 189 and the second hop being one-hop relationship 190. In other words, two-hop neighbors share a common one-hop neighbor. Further, thermostat 114 is three hops away from computer 120, the third hop being one-hop relationship 191 between the air conditioner 112 and the thermostat 114. Throughout this disclosure, devices that are one hop away from each other will be referred to as one-hop neighbors, devices that are two-hops from each other will be referred to as two-hop neighbors, devices that are three hops away from each other will be referred to as three-hop neighbors, and so on. Any devices more than one hop away from each other may be referred to as multi-hop neighbors. In general, n-hop neighbors are neighbors that are linked by (n−1) devices between them.

In FIG. 1, household IoT devices that are within physical range of each other and capable of establishing a one-hop connection are typically referred to as one-hop neighbors, but certain devices may be in physical range of each other and not be able to discover each other through a peer-to-peer discovery protocol for other reasons. Such devices may not be one-hop neighbors, but may still be multi-hop neighbors, connected through other one-hop neighbors. Further, as depicted in FIG. 1, many household IoT devices are commonly situated within ranges of each other that would allow for them to be one-hop neighbors of each other, and possibly all devices in one household could be one-hop neighbors of all other devices in the household. In FIG. 1, however, each IoT device is depicted as having only two one-hop neighbors. The purpose of this depiction is merely to illustrate the concept of one-hop neighbors as compared to multi-hop neighbors, and the devices should not be construed as only capable of connecting in these configurations.

Various protocols currently exist for allowing connected devices to discover each other. Some protocols use “synchronous discovery,” which, as the name indicates, requires that each device “wake up,” or scan for other devices, at the same time. In order to scan at the same time, each device must be in synchronicity with the same clock, such as a global clock. However, maintaining synchronicity with a global clock has various drawbacks, including the amount of data transfer and the amount of power consumption a global clock requires, and because it would be an unnecessary design feature to include a global clock in many IoT devices, especially those that are the most constrained in their capabilities.

Various protocols also exist for “asynchronous discovery,” which, as the name indicates, does not require that multiple devices perform certain functions at the same time. However, such protocols may require even more data transfer and power consumption because of the increased channel scanning required as compared to synchronous discovery.

Examples of existing wireless discovery solutions include LTE Direct, Wi-Fi Direct, Wi-Fi Social, IEEE 802.15.8, WiMedia, and Bluetooth Low Energy. Both synchronous and asynchronous discovery protocols, including the ones listed above, utilize one-hop discovery; that is, a first peer device discovers a second peer device within the radio's transmission range. One-hop discovery inherently limits the discovery of peers to within the geographical range specified by the discovery protocol. As the applications for peer-to-peer networking continue to expand, there exists a need for peer-to-peer devices to be able to discover each other over long distances. There also exists a demand to minimize data transfer and power consumption, especially among constrained devices. For example, a soil sensor in the backyard of a large house may need to discover, and form a wireless connection with, an internet-connected computer within a house, but must do so with limited power, processing, memory, and transmission capability.

In peer-to-peer networks, prior service discovery schemes have used multicasts to establish the presence of peer devices, their capabilities, and relationships within the peer-to-peer network. The peer-to-peer devices have established associations and subsequent interactions, such as wireless connections, based on this information. Embodiments of the present disclosure relate to a peer-to-peer discovery protocol that allows asynchronous discovery of devices on a network, including constrained devices, legacy internet-accessible devices, as well as mobile devices that may move in and out of a peer-to-peer network. These protocols can allow one-to-one broadcasts in place of or in conjunction with multicasts, which may provide the advantages of power conservation and data transfer conservation. Certain embodiments of the disclosure relate to the peer-to-peer discovery protocol allowing multi-hop discovery both locally and over long ranges.

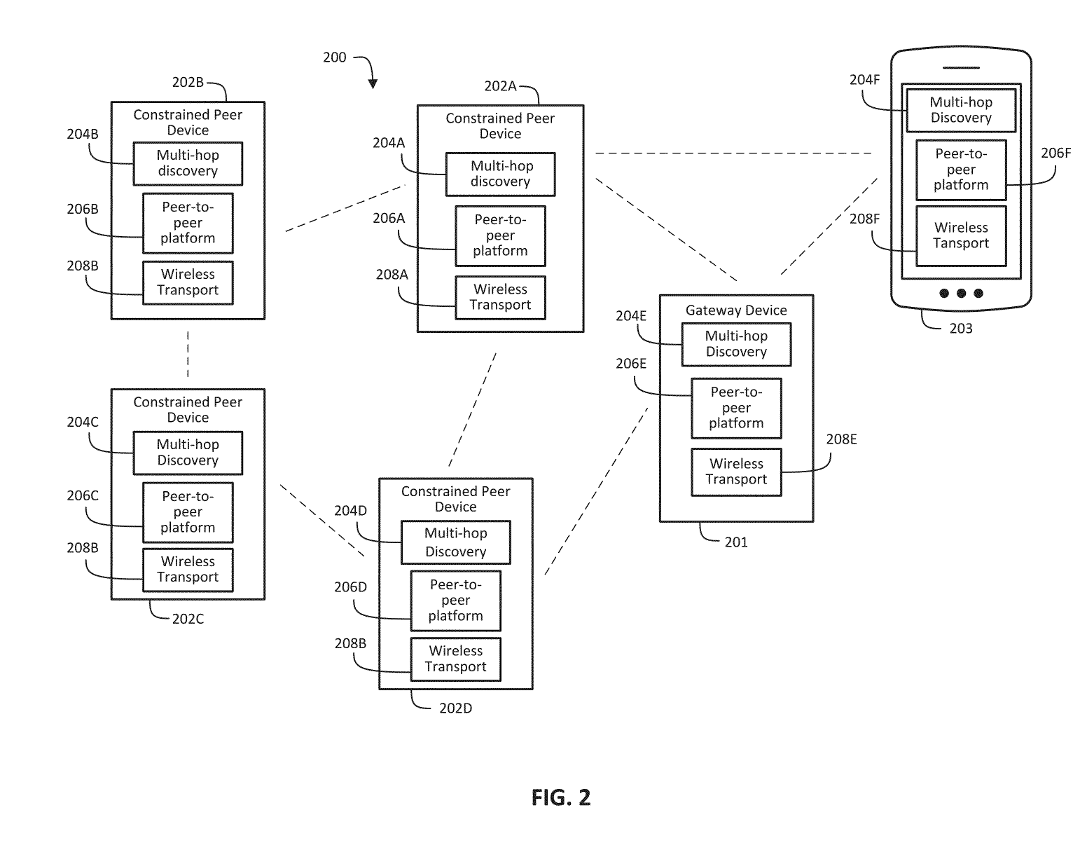

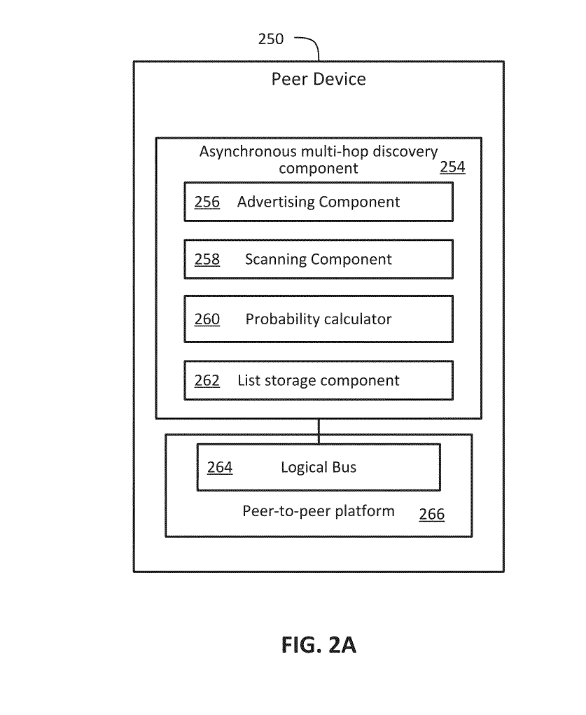

Turning now to FIG. 2, shown is a functional block diagram of wireless communication network 200, depicting several constrained peer devices 202A, 202B, 202C, and 202D within one-hop and multi-hop relationships with each other, with a gateway device 201, and with a mobile communication device 203. The gateway device 201 generally can be a device that manages or controls other peer devices and their communication with each other and with the Internet and/or a server. Related devices that may fall under the general designation of “gateway device” are fully described in U.S. patent application Ser. No. 14/316,254, entitled LEVERAGING SYSTEM SIGNALING SERVICE ADVERTISEMENTS FOR APPLICATION-LAYER DISCOVERY AND CONNECTION MANAGEMENT IN AN INTERNET OF THINGS (IoT) ENVIRONMENT and U.S. patent application Ser. No. 14/316,254, entitled NOTIFICATION DISMISSAL IN AN INTERNET OF THINGS (IoT) ENVIRONMENT, which are incorporated by reference herein in their entirety. Devices described in the above-referenced applications which may act as gateway devices include air interfaces, supervisor devices, IoT servers, and IoT Super Agents. Such gateway devices may form wired or wireless connections with other devices, and as those skilled in the art will appreciate, may be embodied in hardware or in hardware in combination with software. Additionally, the gateway device 201 may be a standalone device or many be integrated within another device. A gateway device 201, like the constrained peer devices 202A-D, also comprises a multi-hop discovery component 204E, a peer-to-peer platform 206E, and a wireless transport 208E. However, in some embodiments, the gateway device 201 may be distinguishable from constrained peer devices 202A-D in that it may have greater functionality or may have more robust wireless transport capabilities, though those components are not depicted. The multi-hop discovery component 204E can be an asynchronous multi-hop discovery component in accordance with embodiments of this disclosure. Similarly, the mobile communication device 203 depicted also comprises a multi-hop discovery component 204F, a peer-to-peer platform 206F, and a wireless transport 208F. Similarly to the gateway device 201, the mobile device 203 may be distinguishable from constrained peer devices 202A-D in that it may have greater functionality or may have more robust wireless transport capabilities, though those components are also not depicted.

Still referring to FIG. 2, constrained devices 202A, 202B, 202C, and 202D include multi-hop discovery components 204A, 204B, 204C, and 202D, which can execute the same or similar multi-hop discovery protocols executed by the multi-hop discovery components 204E and 204F run by gateway device 201 and mobile device 203, respectively.

In the diagram depicted, each device has at least one one-hop relationship with one other device. Some devices have two-hop or three-hop relationships with other device. For example, constrained device 202C only has a two-hop relationship with the gateway device 201, and a three-hop relationship with the mobile device 203. The purpose of this functional block diagram is to illustrate that several types of devices can run the asynchronous multi-hop discovery protocol and thereby discover each other even if they are more than one hop away from each other.

Although not required, the peer-to-peer platforms 206A-206F on each device may be realized by bus-daemons that operate consistent with peer-to-peer technology that is marketed and distributed under the trade name ALLJOYN. Details of the ALLJOYN technology may be obtained at www.alljoyn.org, which provides several documents including the “Alljoyn Android Environment Setup Guide,” among others, which are incorporated herein by reference. In the embodiments where the peer-to-peer platforms 206A-F are implemented as Alljoyn-type bus-daemons, the multi-hop discovery components 204A-F may be implemented as a service that communicates within the Alljoyn peer-to-peer framework. Such a service may be invoked by a method call. For example, in an environment with IoT devices running the multi-hop peer-to-peer discovery protocol in connection with an Alljoyn-type bus-daemon, several components of a residential alarm system may run the protocol. A central alarm hub, door locks, cameras, and motion detectors all may run the protocol. A user with a smartphone enabled with an Allyjoyn-type bus daemon may move from outside the range of these devices to within the one-hop range of one of the devices. For example, the smartphone may move to within one-hop range of the central alarm hub and initiate a method call to the central alarm hub to request the service of the multi-hop peer-to-peer discovery protocol, thereby allowing the mobile phone to discover the other devices within the residential alarm system.

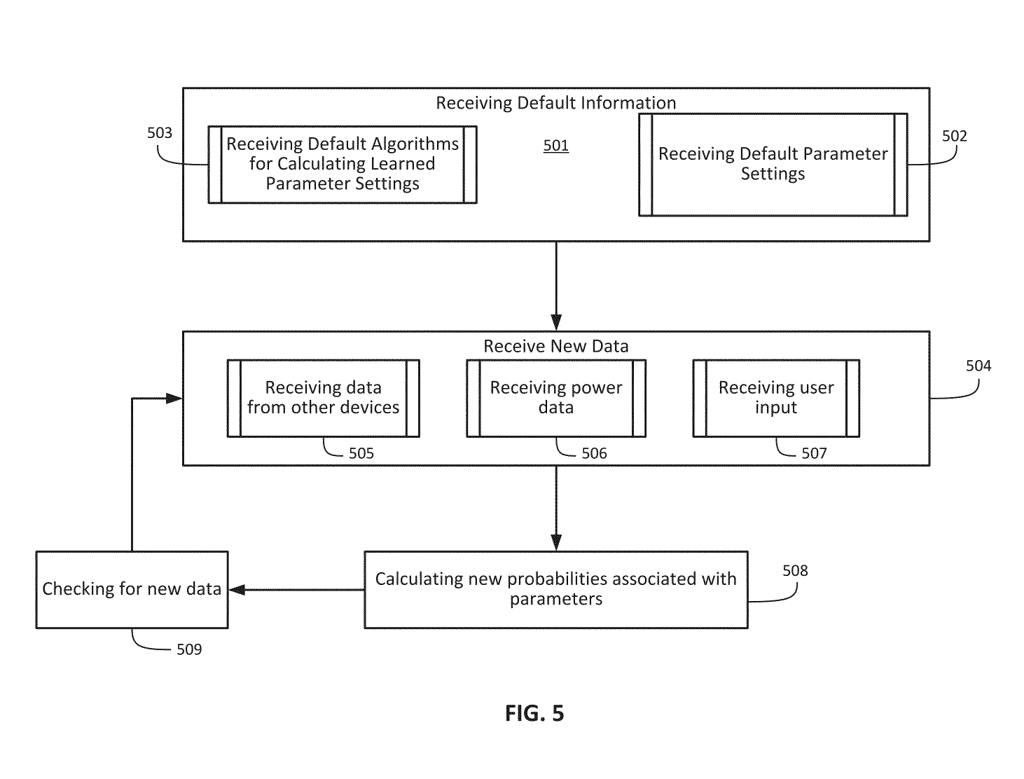

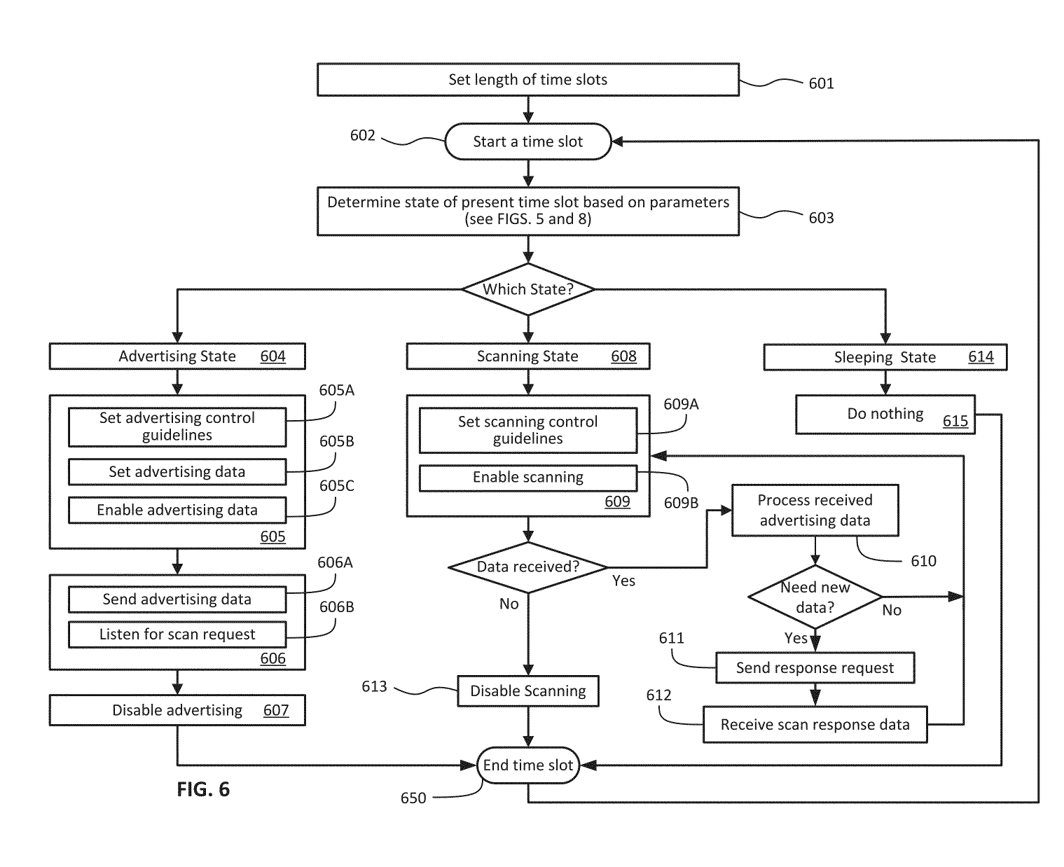

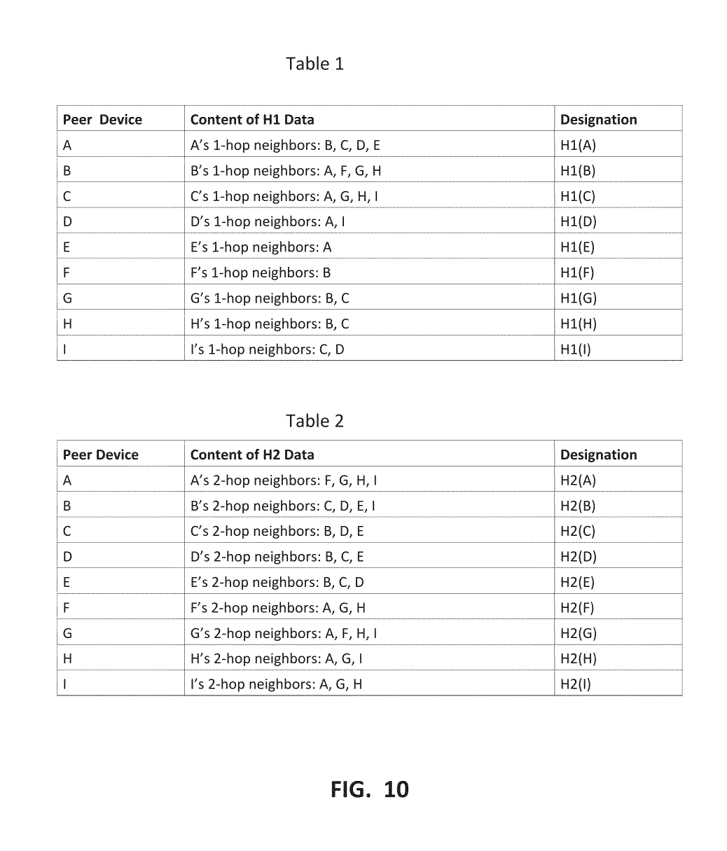

FIG. 2A is a functional block diagram of an asynchronous multi-hop discovery component 254 that may be utilized to realize the multi-hop discovery components 204A-F described with reference to FIG. 2, and can execute various methods described in this disclosure, such as those more fully described in FIGS. 5-9. The blocks as depicted may be implemented as hardware or as hardware in combination with software. Peer device 250 may be realized by any type of peer device 202A-D, or gateway device 201, or mobile device 203, as described with reference to FIG. 2. First, the asynchronous multi-hop discovery component 254 can comprise an advertising component 256, which may carry out aspects of the disclosure such as those described with reference to FIG. 6, Blocks 605, 606, and 607. Next, there can be a scanning component 258 that may carry out aspects of the disclosure such as those described with reference to FIG. 6, Blocks 609-613. The asynchronous multi-hop discovery component 254 may also contain a probability calculator 260 that may carry out aspects of the disclosure such as those described with reference to FIG. 5. Next, there can be a list storage component 262 that may store information for executing aspects of the disclosure as described with reference to FIGS. 10-15. The asynchronous multi-hop discovery component 254 is connected to a logical bus 264, which may be implemented within a peer-to-peer platform 266. The peer-to-peer platform 266 may be utilized to realize peer-to-peer platforms 206A-F as described with reference to FIG. 2. As will be described throughout this disclosure, the probability calculator 260 may influence the activity of the advertising component 256 and scanning component 258 and vice versa. The list storage component 262 may provide necessary content for the advertising component 256, 258, and 260. It is contemplated that each of the components 256, 258, 260, and 262 may interact with each other to carry out various aspects of this disclosure.

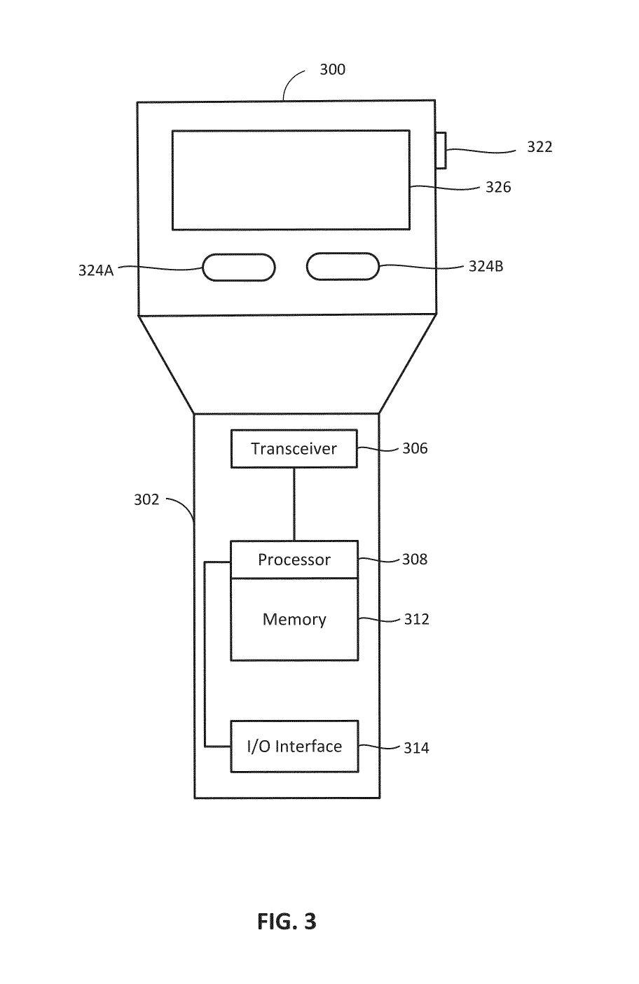

FIG. 3 illustrates a high-level example of an IoT device 300 in accordance with aspects of the disclosure. While external appearances and/or internal components can differ significantly among IoT devices, some IoT devices will have some sort of user interface, which may comprise a display and a means for user input. IoT devices without a user interface can still be communicated with remotely over a wired or wireless network. In general, IoT device 300 may represent a mobile communication device that is not significantly constrained in any way, or a device that has some constraints as described previously

In an example configuration for the IoT device 300, an external casing of IoT device 300 may be configured with a display 326, a power button 322, and two control buttons 324A and 324B, among other components, as is known in the art. The display 326 may be a touchscreen display, in which case the control buttons 324A and 324B may not be necessary. While not shown explicitly as part of IoT device 300, the IoT device 300 may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 300, can be embodied with different hardware configurations, a basic high-level configuration for internal hardware components is shown as platform 302 in FIG. 3. The platform 302 can receive and execute software applications, data and/or commands transmitted over a network interface. The platform 302 may be utilized to realize the multi-hop discovery components 204A-F as depicted in FIG. 2. The platform 302 can also independently execute locally stored applications. The platform 302 can include one or more transceivers 306 configured for wired and/or wireless communication (e.g., a Wi-Fi transceiver, a Bluetooth transceiver, a cellular transceiver, a satellite transceiver, a GPS or SPS receiver, etc.). It is contemplated that certain constrained IoT devices will only include transceivers 306 that are relatively low-power and low-range, and may not include the higher-powered and higher-range transceivers listed as examples. The transceiver 306 can be operably coupled to one or more processors 308, such as a microcontroller, microprocessor, application specific integrated circuit, digital signal processor (DSP), programmable logic circuit, or other data processing device, which will be generally referred to as processor 308. The processor 208 can execute application programming instructions within a memory 312 of the IoT device. The memory 312 can include one or more of read-only memory (ROM), random-access memory (RAM), electrically erasable programmable ROM (EEPROM), flash cards, or any memory common to computer platforms. One or more input/output (I/O) interfaces 314 can be configured to allow the processor 308 to communicate with and control from various I/O devices such as the display 326, power button 322, control buttons 324A and 324B as illustrated, and any other devices, such as sensors, actuators, relays, valves, switches, and the like associated with the IoT device 300.

Accordingly, an aspect of the disclosure can include an IoT device (e.g., IoT device 300) including the ability to perform the functions described herein. As will be appreciated by those skilled in the art, the various logic elements can be embodied in discrete elements, software modules executed on a processor (e.g., processor 308) or any combination of software and hardware to achieve the functionality disclosed herein. For example, transceiver 306, processor 308, memory 312, and I/O interface 314 may all be used cooperatively to load, store and execute the various functions disclosed herein and thus the logic to perform these functions may be distributed over various elements. Alternatively, the functionality could be incorporated into one discrete component. Therefore, the features of the IoT device 300 in FIG. 3 are to be considered merely illustrative and the disclosure is not limited to the illustrated features or arrangement.

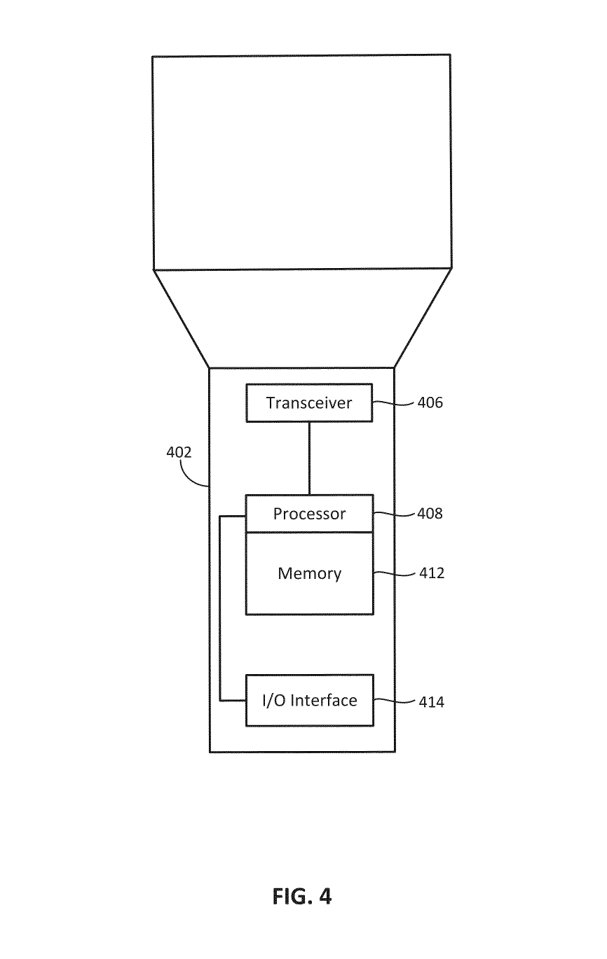

FIG. 4 illustrates a high-level example of a constrained IoT device 400 in accordance with aspects of the disclosure. In general, the passive IoT device 400 shown in FIG. 4 may include various components that are the same and/or substantially similar to the IoT device 300 shown in FIG. 3, which was described in greater detail above. As such, for brevity and ease of description, various details relating to certain components in the constrained IoT device 300 shown in FIG. 3 may be omitted herein to the extent that the same or similar details have already been provided above in relation to the IoT device 300 illustrated in FIG. 3.

The constrained IoT device 400 shown in FIG. 4 may generally differ from the IoT device 300 shown in FIG. 3 in that the IoT device 400 may be highly constrained in nearly every capability. It may not have a power button, a user interface, any buttons, or certain other components. Instead, in an embodiment, the passive IoT device 400 may only include a short-range transceiver 406 such as a Bluetooth radio, and a processor 408, memory 412, and I/O interface 414 that have minimal capacity, such that would only be sufficient for performing simple, device-specific tasks and executing an asynchronous wireless multi-hop discovery protocol in accordance with the present disclosure. For example, the IoT device 400 can be a solar-powered soil sensor, its device-specific tasks consisting of detecting soil pH and moisture and transmitting that information. In order to transmit that information efficiently, the soil sensor also has the capability, provided by the platform 402, to discover other peers in a network. In another example, the IoT device 400 can be a wearable, coin-cell (e.g., lithium-ion battery) powered diaper moisture detector. The device-specific task could consist of detecting moisture and transmitting that information, which could be performed via platform 402.

The foregoing descriptions and examples of FIGS. 3 and 4 help illustrate the range of devices on which the discovery protocol of this disclosure may be performed. While the benefits of such a discovery protocol, such as conserving power and data transmission, are essential to highly constrained devices, the benefits can be of value for more robust devices, given that there exists a constant demand for performance improvement of the most advanced communication devices.

### Peer-to-Peer Asynchronous Discovery Protocol

Referring now to FIG. 5, shown is a flowchart depicting a method by which parameters corresponding to states of a discovery protocol may be derived. As discussed in this disclosure, “parameters” refer to a set of conditions that influence the state of a peer device. For purposes of this disclosure, there can be three parameters, which can correspond to three device states. The parameters can be designated Pₜ, which corresponds to a device advertising state, Pᵣ, which corresponds to a device scanning state, and Pₛ, which corresponds to a device sleeping state. For purposes of introducing the concept of parameters as discussed in this disclosure, one feature of these parameters is that all three exist simultaneously, with one parameter having a greater probability associated with it than either of the other two parameters. The parameter with the greatest associated probability can be referred to as the dominant parameter. More detail regarding the various states and their relationships to their corresponding parameters will be described presently.

The flowchart in FIG. 5 depicts how parameters within a device can be initially set and then changed over time. As shown at 501, a device initially receives default information regarding parameters, which may include receiving default parameter settings at 502. For example, a manufacturer of a device can store certain default parameter settings (e.g., in non-volatile memory that is accessed in connection with initiation of a multi-hop discovery component 204A-F. Such default parameter settings can generally convey to a device that at a particular time of day, or for a particular period of time, the parameter Pₜ will be the dominant parameter. Default parameter settings set by the manufacturer can assign what the dominant parameters may be during any particular time period in the absence of any additional input received by the device upon installation or activation.

One aspect of the disclosure is that devices may “learn” to change its parameter settings from the default parameter settings such that the probabilities associated with certain parameters change, and consequently dominant parameters associated with particular time slots also change. A benefit to learning new parameter settings is that a device can conserve power and data transmission based on input from its environment. In order to calculate new parameter settings, the device may receive default algorithms for calculating learned parameter settings (Block 503). The manufacturer of the device may program these algorithms in software executed by hardware, or the algorithms may be executed completely by hardware (e.g., an FPGA or ASIC). Thus, receiving default information (Block 501) can include receiving default parameter settings (Block 502) and receiving default algorithms for calculating learned parameter settings (Block 503).

Once a connected device is activated or installed, or is otherwise in use, it may be placed within a network wherein it may discover peers and otherwise receive information from peers, as well as receive information from its environment and a user. A connected device in accordance with embodiments of this disclosure may receive information regardless of whether any other connected devices within a network perform the asynchronous multi-hop discovery protocol described herein. As shown at 504, receiving new data can include receiving data from other devices (Block 505). Such data can include, but is not limited to, discovery protocol information, proximity information, and information about other devices' capabilities. Such information about other devices' capabilities can include, but is not limited to, wireless transmission equipment and range, processing capability, memory capacity, functions, mobility, power sources, power usage, and internet connectivity. As shown at 504, receiving new data can also include receiving power data (Block 506). Such information can include whether the device itself is connected to mains AC power, or is powered by a coin cell, other battery, or solar power, for example. Receiving power data (Block 506) can also include receiving data that is indicative of whether the device is powered by more than one source of power at various times. For example, a device may be powered solely by a battery at times, but may also be powered by mains AC power at other times. Some devices may receive new power data frequently; many battery operated devices can be recharged, and may use AC power as an alternative source while charging.

Still referring FIG. 5, receiving new data (Block 504) may also include receiving user input (Block 507). A user may program a device in a variety of ways in order to achieve desired attributes of the device. For example, a user may want a certain device to conserve power at the expense of better performance, or vice versa. It is contemplated that certain robust devices may be capable of receiving extensive user input, while some more constrained devices may receive little or no user input. Alternatively, it is contemplated that certain devices may receive minimal, general input from a user, but may perform complex functions based on the minimal input. For example, a user may instruct a thermostat or a sprinkler controller simply to operate in a “power save” or “water save” mode, upon which the device may perform a variety of sensory tasks, run programs, and regulate its own actions. Information about the device's own tasks may be included in receiving user input (Block 507).

As shown at 508, calculating new probabilities associated with parameters can be performed by using the default algorithms shown at 503 with all or some of the new data shown at 504. By calculating new probabilities associated with parameters, a device can learn to have new dominant parameters replace the default dominant parameters (Block 501). As will be described in more detail presently, calculating, or learning new parameter settings can enable a device to conserve power and data transmission.

Many devices capable of performing the method depicted in FIG. 5 will receive new data periodically, or even frequently. After a device has calculated new probabilities associated with new parameters (Block 508), it can then check for new data (Block 509). If the device receives new data (Block 504), it may then calculate new probabilities associated with new parameters again (Block 508). By repeating the processes shown 508, 509, and 504, a device may continuously learn and recalculate new probabilities associated with parameters, which may thereby change other characteristics of the device.

Referring now to FIG. 6, shown is a flowchart by which a device may determine and perform various states within discrete time slots. Beginning at 601, the device sets the length of time slots during which it may run through various states. The length of time slots may be set by the manufacturer or may be an industry-standard time slot determined by the type of wireless transceiver with which a device is equipped. For example, a Bluetooth Low Energy (BLE) radio uses time slots for discovery and transmission of data that are 0.625 milliseconds in length, or multiples thereof. However, it is contemplated that time slots may be determined by other hardware or software standards, or may be customized by a user or manufacturer.

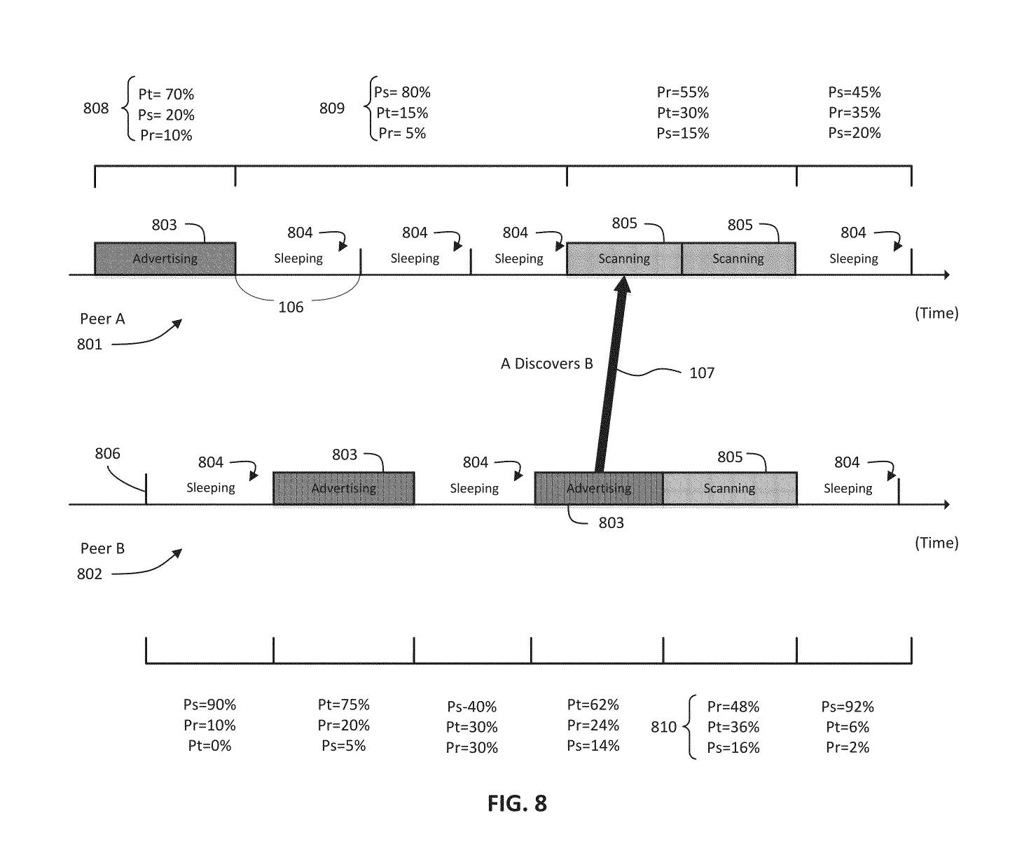

Once some specific time slots are set, a time slot may start as shown at 602. At the beginning of the time slot, the device determines the state in which the device will operate during the time slot as shown at 603. This determination can be made based on default or learned parameter settings as described in FIG. 5. The probabilities associated with each parameter can be determined by the method shown in FIG. 5, and can result in probabilities such as the ones shown as examples in FIG. 8, which will be described in further detail later in this disclosure. One of the possible parameters Pₜ, Pᵣ, or Pₛ, which correspond to states of advertising, scanning, and sleeping, respectively, can be the dominant parameter for this particular time slot, which will result in the device running the corresponding state.

If the dominant parameter is Pₜ, the device will enter the advertising state as shown at 604. Once in the advertising state, a device (e.g., any of the IoT devices described with reference to FIG. 1) will run the advertising protocol, as shown at 605, 606, and 607. For the purposes of this disclosure, the terms “broadcasting,” “advertising,” “sending advertising data,” and “data transmission” may be used interchangeably, with the terms encompassing both multi-cast and uni-cast data transmission. Within the advertising protocol shown at 605, the device will set advertising control guidelines (Block 605A). Advertising control guidelines can include when and how often a device broadcasts data. A device may broadcast continuously, intermittently, or perhaps just once during a given advertising state time slot. During the advertising protocol shown at 605, the device may also set the content of the advertising data that it will broadcast. The advertising data that it will broadcast may include information about other peers in a peer-to-peer network as described throughout this disclosure. The advertising data that is set at 605B may include different data for a multi-cast message than for a uni-cast message. For example, some advertising data may be set at 605B to be sent only as a uni-cast message, and only in response to a request from another device. During the advertising protocol shown at 605, the device may also enable the advertising (Block 605C). Each process shown at 605A, 605B, and 605C may be carried out in sequence or simultaneously.

In the advertising protocol, at 606, the device sends advertising data (Block 606A) and listens for scan requests (Block 606B). The advertising protocol can have a listening component as shown at 606B in order to facilitate discovery of other devices that may be in a scanning state. For example, the device may send advertising data (Block 606A) as a multi-cast message, which is detectable by many other peer devices. Then it may listen for a scan request (Block 606B) and receive such a scan request from one particular peer device. Then it may send advertising data (Block 606A) as a uni-cast message to the particular peer device from which it received a scan request. Then as shown at 607, the advertising protocol disables advertising. The time slot then ends (Block 610). The disabling advertising (Block 607) and the end time slot (Block 650) may occur in sequence or simultaneously.

Still referring to FIG. 6, a device may enter a scanning state instead of an advertising state. The device enters the scanning state as shown at 608, during which it runs the scanning protocol shown at 609, 610, 611, 612, and 613. For the purposes of this disclosure, the terms “scanning” and “listening” may be used interchangeably. A scanning protocol begins at 609, wherein the device sets scanning control guidelines (Block 609A) and enables scanning as (Block 609B). The scanning control guidelines shown at 609A can include how long and how frequently a device actively scans during a scanning state. Setting scanning control guidelines (Block 609A) and enabling scanning (Block 609B) may be performed in sequence or simultaneously.

When a device is scanning or listening, it is able to detect messages broadcast by devices, if any, that are within its physical range and are in an advertising state. If advertising data is not received, and the time slot is coming to an end, the device may disable scanning as shown at 613. If, however, the device does detect advertising data, then it may process received advertising data (Block 610). Processing received advertising data (Block 610) can include the device determining what information it has received and whether it has received that particular information before. For example, a peer device A in a scanning state may be in close proximity to a peer device B in advertising state from which peer A has received advertising data before. The peer device B may be broadcasting information regarding other peers it has discovered. If peer device B has not discovered any new peers since the last time peer device A had received peer device B's advertising data, then the peer device A would not require all the information that peer B has available. It is contemplated that multi-cast advertising data may contain limited information regarding newly discovered peers. That is, multi-cast advertising data may only indicate whether or not a peer device such as peer B has discovered a new peer. It may not include identifying information about a newly discovered peer. By limiting the information in an advertising multi-cast, a device may conserve data transmission. In the scanning protocol, if a device processes received advertising data (Block 610) and determines that it does not need new data from another device, it may then disable scanning (Block 613) and the time slot may end (Block 650).

If, at 610 of the scanning protocol, the device determines that it does need new data from a broadcasting peer device, then it send response request data (Block 611). As the advertising protocol as shown at 605-607 had a listening component, so does the scanning protocol have a broadcasting component, as shown at 611. While sending response request data (Block 611), the data may be broadcast as a uni-cast message to the device from whom it received advertising data (Block 610). Once the device has sent response request data (Block 611), it may then receive scan response data (Block 612). Scan response data could be sent to the device that is in a scanning state from another device in the advertising state. For example, the scan response data could have been broadcast as a uni-cast message from a device in advertising state to a device in scanning state. Once scan response data has been received (Block 612), the device may return to the beginning of the scanning protocol (Block 609). When the time slot nears its end, scanning can be disabled (Block 613). The disabling of scanning (Block 613) and the end of the time slot (Block 650) can occur separately or simultaneously.

In either the advertising protocol as shown at 605-607 or the scanning protocol as shown at 609-613, some of the processes depicted may be repeated multiple times throughout a particular time slot. For example, Block 606 of the advertising protocol and Blocks 610-612 may be repeated.

Still referring to FIG. 6 but now turning to sleeping state 614, a device may enter the sleeping state 614 if the dominant parameter is determined Pₛ (Block 603). In the sleeping state 614, the device does nothing (Block 615), and then the time slot ends (Block 650). During the sleeping state 614, the device may conserve power and data transmission because it is not performing any functions, and it may not discover other peers or be discovered by other peers.

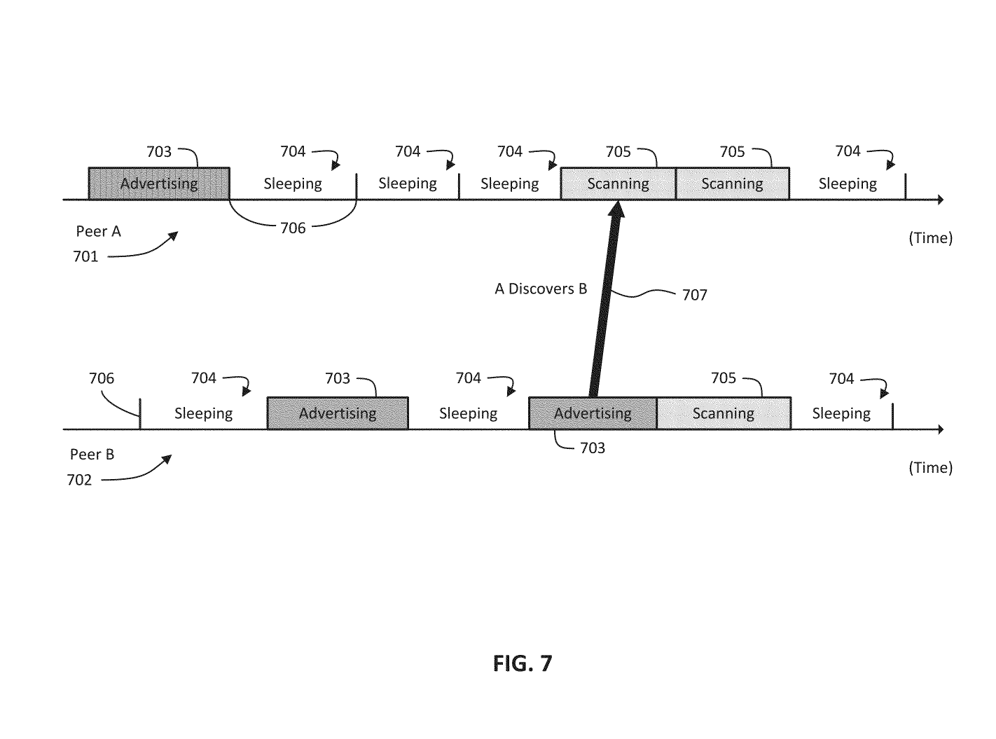

Referring next to FIG. 7, it is a timeline depicting two communication devices in various states over time, which further illustrates the methods of discovery depicted in FIG. 6. Because FIG. 7 depicts various states over time, it shows how the method of discovery may be asynchronous. Connected devices Peer A 701 and Peer B 702 each run through asynchronous discovery protocols that include various states such as advertising state 703, sleeping state 704 and scanning state 705. In this timeline, the time is divided into small time slots, which are denoted by markers 706. As previously discussed, the time slots may be determined by standards of the wireless transceiver equipment of the device. As depicted, each device runs through its own protocol of states. For purposes of clarity, the sequence of states may be referred to herein as a “discovery protocol.” Additionally, an individual advertising state has an advertising protocol and an individual scanning state has a scanning protocol, as discussed in FIG. 6. In this example, Peer A 701 consecutively runs through the states of advertising 703, then sleeping 704, then sleeping 704, then sleeping 704, then scanning 705, then scanning 705, and then sleeping 704. Peer B 702 also runs through a discovery protocol independently of Peer A 701. In this example, Peer B's 702 first time slot does not start at the same time as Peer A's 701 first time slot (i.e., they are asynchronous). Additionally, Peer B 702 runs through states in a different order and frequency than Peer A 701. Peer B 702 consecutively runs through the states of sleeping 704, then advertising 703, then sleeping 704, then advertising 703, then scanning 705, and then sleeping 704.

Still referring to FIG. 7, when Peer B 702 is in advertising state 703 during a time period which overlaps with a scanning state 705 of Peer A 701, Peer A 701 “discovers” Peer B 702. In this embodiment, the discovery occurs because during advertising state 703, Peer B 702 sends out advertising data 707, which can also be referred to as an advertising packet, a data packet, or a beacon. Though the second advertising State 703 in Peer B 702 is depicted sending advertising data 707, all advertising states 703 can send similar advertising data as described with reference to FIG. 6.

Referring now to FIG. 8, shown is the timeline as depicted in FIG. 7 with corresponding sets of parameters superimposed above each state. Each peer, such as Peer A 801 and Peer B 802, determines what states to cycle through based on which parameter of the three possible parameters Pₛ, Pₜ, and Pᵣ is dominant. A dominant parameter, as described previously, is the parameter that has the greatest probability associated with it compared to the other two parameters. The probabilities themselves are formulated using the data and algorithms as described with reference to the flowchart of FIG. 5. Each time slot on the timelines depicted in FIG. 8 has three possible parameters that exist at the same time. The parameters exist in relation to each other such that they each comprise a percentage, and the percentages add up to 100%. The parameter that has the greatest assigned probability associated with it becomes the dominant parameter. For example, for the first set 808 of Peer A's 801 parameters, the method depicted in FIG. 3 may calculate that there is a 70% likelihood that the device should be advertising, represented as Pₜ=70%, a 20% chance that the device should be sleeping, represented as Pₛ, and a 10% chance that it should be scanning, represented as Pᵣ=10%. Given these parameters, Pₜ is dominant and the device will go into an advertising state. Peer A's 801 second set of parameters 809 shows Pₛ=80%, Pₜ=15%, and Pᵣ=5%. Therefore, Peer A 801 enters a sleeping state. As another example, Peer B's fifth set of parameters 810 shows Pᵣ=48%, Pₜ=36%, and Pₛ=16%. Therefore, Peer B 802 enters scanning state.

FIG. 8 includes other examples of sets of parameters that can be associated with time slots and with particular states. The dominant parameter need not be a particular number, or be much higher than the other parameters. Dominant parameters may be much larger or smaller during certain time periods, and may vary drastically even between adjacent time slots. There are numerous circumstances within the environment of a household with multiple IoT devices that can impact the parameters and their associated probabilities. For example, an IoT lighting system may be located at the front of a house, and may frequently need to discover smartphones entering and exiting the peer-to-peer network, but may also be dependent on sensory information received from multi-hop neighbor stationary devices at the back of the house. The IoT lighting system might therefore learn quickly that it will not likely need to re-discover its multi-hop neighbors very frequently during the middle of the day, from 10 am to 2 pm, for example. Therefore, its dominant parameter may be Pₛ for most of that time period. However, it may learn that it is likely to discover new entering peers, such as smartphones, between 3 pm and 6 pm, and therefore it may have a dominant advertising parameter Pₜ or scanning parameter Pᵣ during that time period.

### Multi-Hop Discovery Method

The preceding section described how an asynchronous discovery protocol may performed. The present section now turns to describing how the previously described asynchronous discovery protocol may be used to perform multi-hop discovery. Specifically, the present section describes the nature of the information that may be broadcasted during an advertising state of the asynchronous discovery protocol.

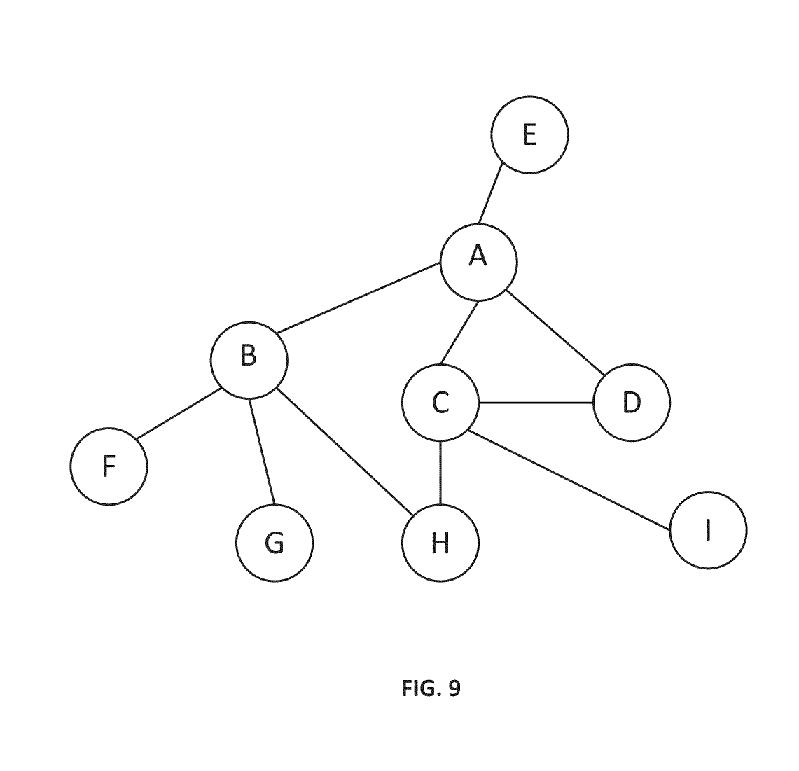

Referring now to FIG. 9, shown is a schematic diagram depicting generic representations of connected devices, such as the kind generally depicted in FIGS. 3 and 4. For the purposes of FIGS. 9-14, peer devices will be labeled and referred to by letters. FIG. 9 specifically shows a network of peer devices A, B, C, D, E, F, G, H, and I and their hop-relationships to each other. In FIG. 9 and subsequent figures, a solid line between a pair of peer devices represents a one-hop relationship. The relationships between the peer devices A-I in FIG. 9 will form the basis for the tables and diagrams in subsequent figures. Devices are said to be one-hop neighbors when one device can discover another through the advertising and scanning protocols as described in FIGS. 6-8, because they are within physical wireless transmission range of each other.

Still referring to FIG. 9, and beginning with peer device A, A has four one-hop neighbors B, C, D, and E. A also has two-hop neighbors F, G, H, and I. Turning to peer device B, B has one-hop neighbors A, F, G, and H, and has two-hop neighbors C, D, and E. B also has a three-hop neighbor, I. Each of the individual peer devices one-hop, two-hop, and three-hop neighbors may be identified similarly by counting the number of solid lines in between one peer device and another.

FIG. 10 depicts two tables which contain information derived from the diagram in FIG. 9. Table 1 lists each peer device in the first column. The second column is entitled “Content of H1 Data” and lists, next to each corresponding peer device, all of its one-hop neighbors. The third column is entitled “Designation” and lists how each peer device's one-hop neighbors may be designated for reference in subsequent figures for clarity when multiple devices and multiple sets of data are described. Thus, Table 1 shows that peer device A (first column) has H1 data which contains the information that its one hop neighbors are B, C, D, and E (second column) A's H1 data is designated H1(A) (third column).

Similarly, FIG. 10 contains Table 2, which shows the content of each peer device's H2 data and the designation thereof. For example, Table 1 shows that peer device A (first column) has H2 data which contains the information that its two-hop neighbors are F, G, H, and I (second column). A's H2 data is designated H2(A). In a similar manner, each peer device's two-hop neighbor data can be designated. All of D's two hop neighbors are designated as H2(D), all of E's 2 hop neighbors are designated H2(E), and so forth. The designations described herein are merely for the purposes of illustrating the concepts of the data that is used in accordance with this disclosure. The designations are for the purposes of describing concepts in this disclosure, and are not to be construed as actual code or instructions that may be used in actual embodiments.

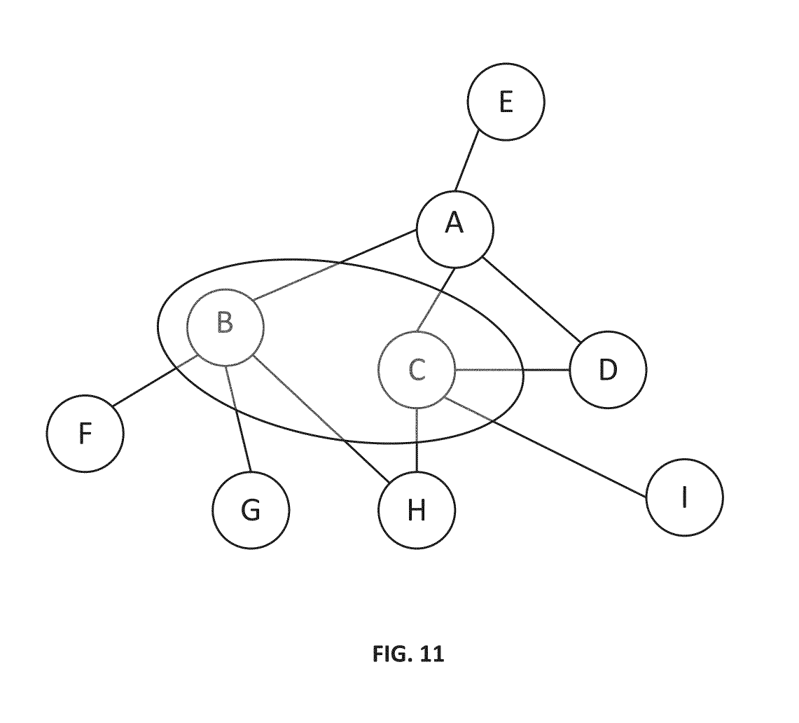

Turning now to FIG. 11, shown is the same diagram of peer devices as FIG. 9, with peers B and C encircled. Peers B and C are encircled specifically to highlight their neighbor relationships with A and other peers in this diagram. B and C are both one-hop neighbors of A. B and C have a different kind of relationship to A than A's other one-hop neighbors E and D, which is that B and C are both one-hop neighbors of F, G, H, and I. An aspect of the disclosure is that each peer device can store information about its own one-hop neighbors (i.e., H1 data). This information may be stored on a short-term basis and may change as one-hop neighbors change. Further, each peer device may broadcast information about its own one-hop neighbors to other one-hop neighbors. For example in FIG. 11, B and C each store their own H1 data. B stores H1(B) and C stores H1(C). Peers B and C therefore also broadcast their H1(B) and H1(C), respectively, to all their one-hop neighbors, so that some of their one-hop neighbors may discover that they have previously unknown two-hop neighbors. To take B, for example, B broadcasts its H1(B) data, which indicates that B's one hop-neighbors are F, G, H, and A. Peers F, G, and H do not necessarily need this information, for they already “know” they are one-hop neighbors of B by virtue of being in physical wireless transmission range of B. However, A may not know that B's other one-hop neighbors are F, G, and H. Therefore, by way of B, A now learns that it has two-hop neighbors F, G, and H. An aspect of this disclosure is that each device can store information about its two-hop neighbors. Another aspect of this disclosure is that if devices know they have neighbors to whom they may connect by multiple hops, they can form a network. That is, each peer can transmit information of various types and sizes to other peers via the connecting peers. For example, A may transmit information to F via B. Such information may contain many more bytes of data than discovery information.

Still referring to FIG. 11, and now using Peer C as an example, C has one-hop neighbors A, D, H, and I. Therefore, C stores this information as H1(C) and broadcasts it out to each of its one-hop neighbors. As C broadcasts this information to A, A discovers that it has an additional two-hop neighbor, I, that was previously undiscovered. A already discovered D, because D is a one-hop neighbor to A. A also already discovered H as a two-hop neighbor, because of B. A also receives D's H1(D) data and E's H1(E) data, but that data does not indicate that A has any additional two-hop neighbors. A has a complete list of all of its two-hop neighbors.

Another aspect of the present disclosure is that A (and other peers) can enable multi-hop discovery by making its one-hop neighbors known to its two-hop neighbors. In this example, A can select a subset of its one-hop neighbors in order to transmit A's H1(A) data to its two-hop neighbors. In this case, B and C can transmit A's H1(A) data to F, G, H, and I. A's H1(A) data includes E. Now, F, G, H, and I, have learned that they have a previously undiscovered three-hop neighbor, E. It is contemplated that a device such as A can select the smallest possible set of one-hop neighbors that can reach A's two-hop neighbors. In this example, peers D and E do not need to broadcast A's H1(A), because the information would be unnecessary and redundant. If they did, E would be broadcasting H1(A) data only back to A, and D would be broadcasting H1(A) data only back to A and C. A generated the H1(A), data, and C already has this information. By selecting the smallest possible subset (B and C) that can reach all of A's two-hop neighbors, peers in the network can conserve power and data transmission. It is contemplated that in some embodiments, there may be more than one possible set of one-hop neighbors that can cover all of a peer's two-hop neighbors.

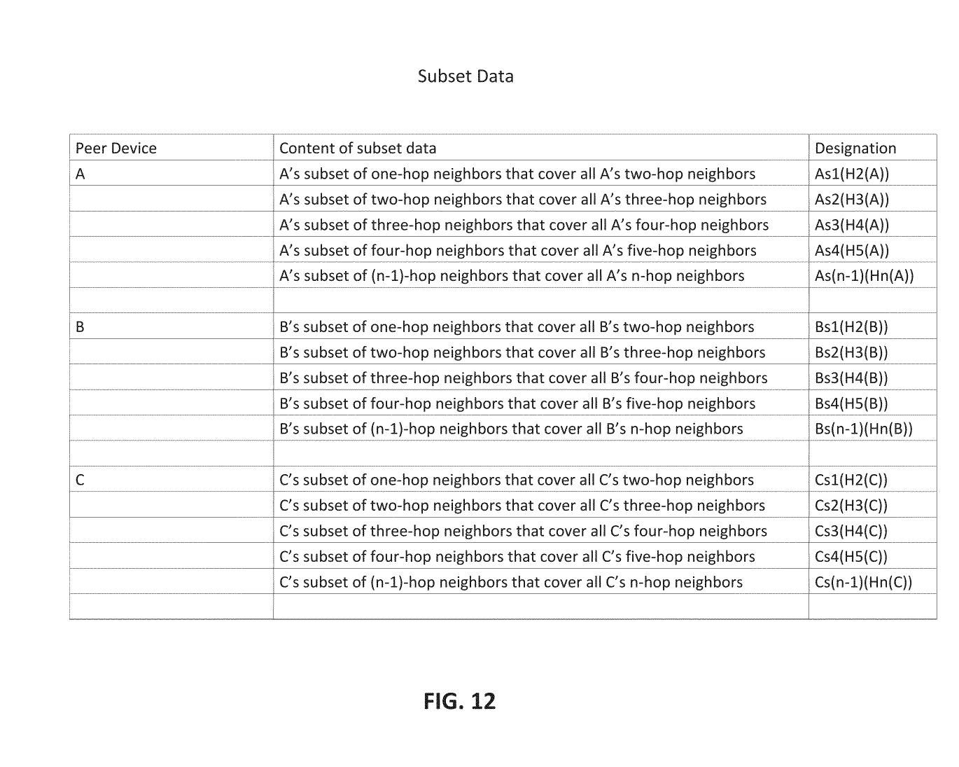

Now referring to FIG. 12, shown is a table entitled “Subset Data” that illustrates examples of data and their designations for the purposes of describing concepts of this disclosure. Multiple examples are provided in for the purposes of clarity. The first column simply lists peer devices A, B, and C. The second column describes a set of data that will be referred to as “subset data” in this disclosure. The third column lists designations that correspond with particular descriptions of subset data. For example, the first entry in the second column describes “A's subset of one-hop neighbors that cover all of A's two-hop neighbors.” This particular subset data is designated, as listed in the third column, as “As1(H2(A))” Other subset data is designated with a similar pattern. For example, “B's subset of two-hop neighbors that cover all of B's three-hop neighbors” is designated as “Bs2(H3(B)).” This example holds for up to the variable n number of hops, wherein n represents the furthest discovered multi-hop neighbor of a particular device. Therefore, “C's subset of (n−1)-hop neighbors that cover all C's n-hop neighbors is designated “Cs(n−1)(Hn(C)).” The designations are for the purposes of describing concepts in this disclosure, and is certainly contemplated that a variety of other designations may be utilized in actual embodiments.

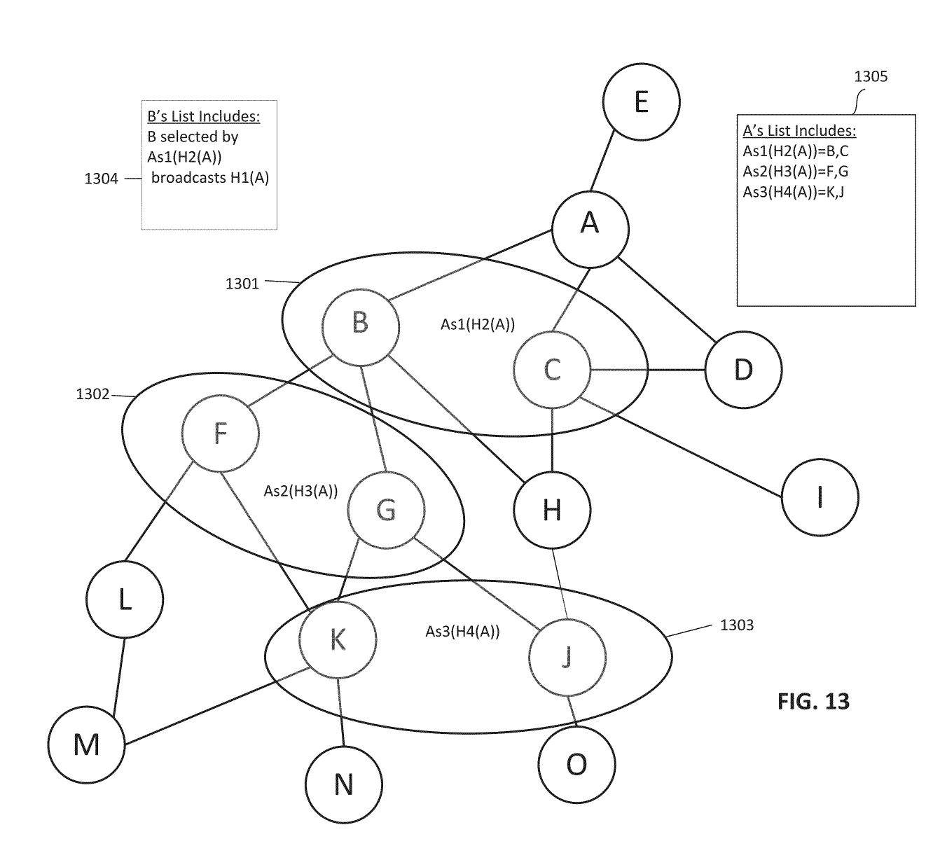

Now turning to FIG. 13, the relationships of peer devices A, B, F, L, and M will be described. The present figure is based on the diagrams of FIGS. 9 and 11, with additional peer devices J, K, L, M, N, and O added. The method described herein teaches how A discovers its three-hop neighbor L and four-hop neighbor M. As described above, each peer is capable of directly broadcasting a message to its one-hop peers. One part of the information each peer broadcasts is who that peer's one-hop neighbors are. For example, A and B are one-hop neighbors that directly broadcast to each other. B's broadcasted information to A includes that F is B's one-hop neighbor. An aspect of the disclosure is that if any new peer devices move into B's range and become one-hop neighbors of B, those new peer devices will discover that A and F are B's one-hop neighbors, and A and F will discover that B has a new (not depicted) one-hop neighbor.

Another aspect of the disclosure is that each device may contain a list, or several lists, of data that enable it to store and broadcast the proper information to allow multi-hop discovery. In the diagram of FIG. 13, B and C are circled at 1301. As indicated by the label within the circle 1301, B and C are part of the subset As1(H2(A)), meaning they are part of A's subset of one-hop neighbors that cover all of A's two-hop neighbors. F and G are encircled at 1302, and are designated as the subset As2(H3(A)), because they cover all of A's three-hop neighbors L, K, and J. K and J are encircled at 1303 and designated as As3(H4(A)), because they cover all of A's four-hop neighbors M, N, and O.

When a device constructs or selects a subset of its neighbors to be in a particular subset, the device stores that subset information in memory. The device that has performed the constructing or selecting then communicates to devices within the selected subset at least two pieces of information, which includes that the selected device is selected, and the H1 data of the selecting device. By way of example, information on A's list is depicted at 1305. A's list includes its constructed and selected subsets As1(H2(A)), As2(H3(A)), and As3(H4(A)). Information on B's list includes at least two pieces of information; that B has been selected by As1(H2(A)), and the data H1(A). B can now broadcast H1(A). Because B broadcasts H1(A), F can discover that A's one-hop neighbor is E.

With reference to additional relationships depicted in FIG. 13, A knows from B that one of A's two-hop neighbors is F. A stores that information in its list of two-hop neighbors known to A, designated as H2(A). F knows that A is a two-hop neighbor as well, so F stores this information in F's own list, under the designation H2(F). F regularly broadcasts information about its own one-hop neighbors to its one-hop neighbors.

In an embodiment of the disclosure, F it can also broadcast, in the same message, information about its discovered two-hop neighbors to its one-hop neighbors. For example, in the diagram, F would broadcast that its one-hop neighbors are L, K, and B. B does not need to know that B itself is F's one-hop neighbor, because it already knows by virtue of being a one-hop neighbor. However, B now learns that L is F's one-hop neighbor, and is therefore a two-hop neighbor of B. Therefore, B discovers that L is its two-hop neighbor. Additionally, F can broadcast not only its one-hop neighbor information H1(F), but also its two-hop neighbor information H2(F). Thus, F broadcasts to L that F's two-hop neighbor is A, and now L knows that A is its three-hop neighbor. By the same logic, this information can also be propagated the other way. That is, B now knows that L is its 2-hop neighbor. B also now broadcasts its information H1(B) and H2(B) to its one hop neighbors, such as A. Now, A knows that L is its three-hop neighbor. Similarly, L knows that A is its three-hop neighbor.

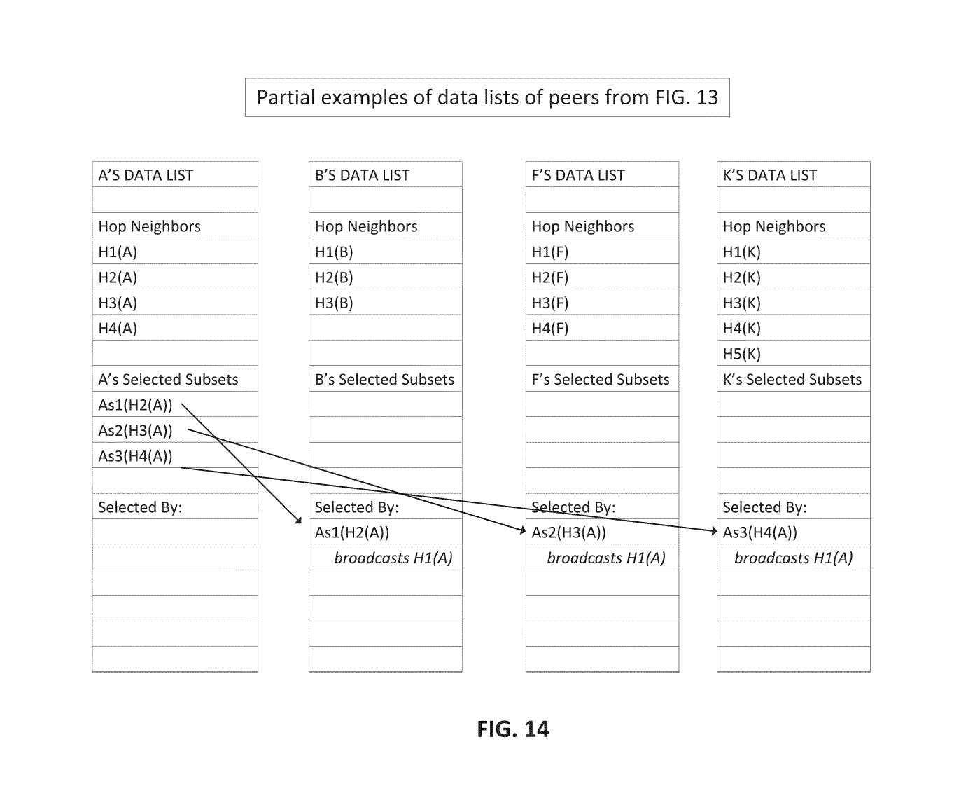

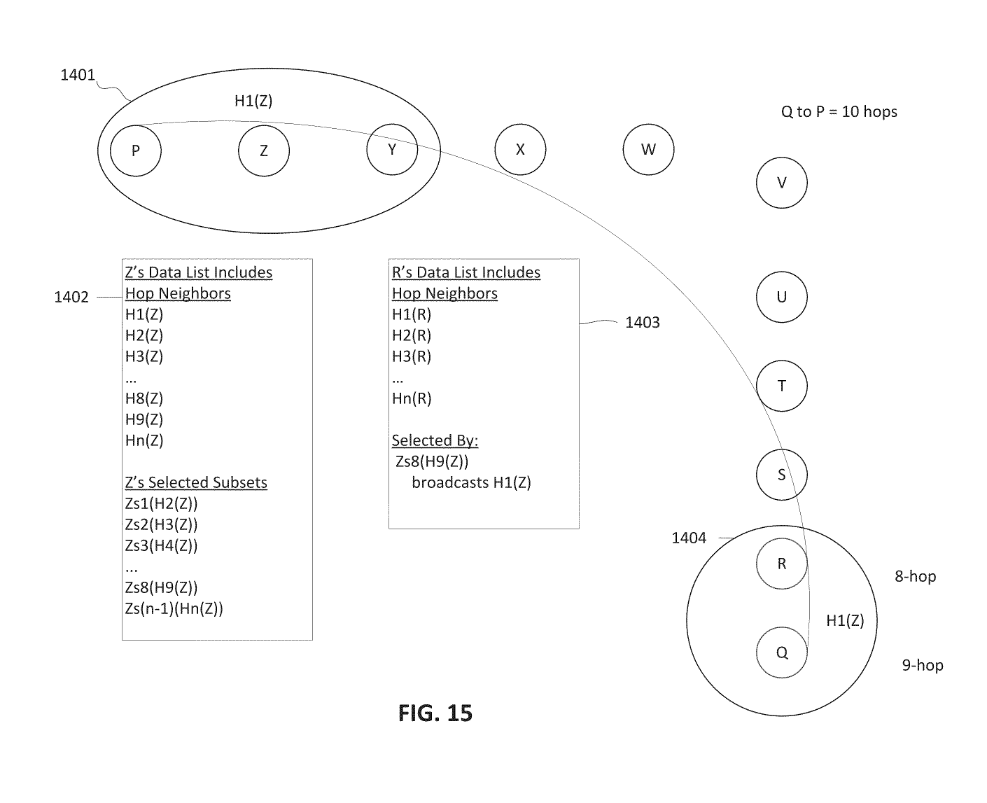

However, even though a device stores a list of all of its known multi-hop neighbors (e.g., H1, H2, and H3 neighbors), in some embodiments of the disclosure, the device may not broadcast all the neighbor information on the list during multi-casts to its own one-hop neighbors, in order to save data transmission and power consumption. In fact, as the number of hops increases between multi-hop neighbors in a network, the more data each device stores, and it may become more advantageous to not broadcast the entire list of multi-hop neighbors. In this case, the devices may instead carry out embodiments of the disclosure wherein each device regularly only multi-casts two particular kinds of information: 1), its own one-hop neighbors, and 2) the one-hop neighbors it has been selected to broadcast by other neighbors. This second type of data will be described in further detail with reference to FIGS. 14 and 15.

In an example wherein a four-hop discovery takes place, it may be more advantageous to carry out an embodiment of the disclosure wherein selected subsets are used. Referring again to FIG. 13, device A can know, through a variety of ways, that L is its three-hop neighbor, and A can store this information as H3(A), but A does not broadcast its H3(A) information to its own one-hop neighbor, E. However, A has selected F as part of As2(H3(A)). As a result, F broadcasts to L the information H1(A). L now knows that one of A's one-hop neighbors is E, and L has thereby discovered a four-hop neighbor, E. This method of transmission may save data and power transmission.

FIG. 14 shows examples of partial data lists for peers depicted in FIG. 13. For clarity and brevity, not all the data maintained by each peer is displayed in each list. In the first table, entitled A's data list, A maintains a list of its known “hop neighbors.” This list includes H1(A), H2(A), and so forth. A's data list also includes “A's selected subsets,” which reflects the same data shown in FIG. 13 at 1305. A's data list can also include a “selected by:” list, which can indicate any other peers that have selected A to be within a subset. There is no data in the “selected by” list for purposes of simplicity; in this example, A could certainly be in a subset of another peer device.

The second table shows B's data list, which includes its hop neighbor list H1(B), H2(B) and H3(B). B's data list also includes B's selected subsets, though none are shown here for simplicity. B's “selected by” list includes that it B has been selected by A and broadcasts H1(A). F and K's data lists are depicted similarly, showing that F and K each store information in their “selected by” lists that indicates they have been selected by A, and therefore broadcast H1(A).

FIG. 15 illustrates a way in which peer devices can discover each other up to n hops, with n being the furthest possible peer in the network from a given first peer. The diagram in FIG. 15 uses peers that are labeled differently and in a different configuration from FIGS. 9, 11, and 13, but similar concepts apply. In FIG. 15, Z will be used as an example of a first peer device. H1(Z) is depicted at 1401, and includes P and Y. The n-hop peer device in this case is Q, which is nine hops away, so in this example, n=9. R is 8 hops away, or n−1 hops away from Z. In the example, Q has not yet discovered P, which is a total of 10 hops away, also known as n+1 hops away. In this example also, Z has discovered all the peer devices in the network, including P and Q. This diagram illustrates how Q may discover P. Z's data list, shown at 1402, shows that Z has discovered and stored information regarding all of its hop neighbors up to H9(Z), which in this case is synonymous with Hn(Z). Z also stores all of its selected subsets, including Zs8(H9(Z)). R's data list shown at 1403 includes that R has been selected by Zs8(H9(Z)), and therefore R broadcasts H1(Z) to Q, depicted at 1404. This broadcast of H1(Z) allows Q to discover that P is a 10-hop neighbor.

As discussed previously with reference to FIGS. 9-15, it is contemplated that each device that discovers multi-hop peers stores a list of its discovered multi-hop neighbors (e.g., H1, H2, H3, etc.). In the example of FIG. 15, lists for each of these devices are large due to the large number of multi-hop neighbors. In this example, it may be advantageous for each device to simply broadcast (in a multi-cast) 1) a list of its one-hop neighbors and 2) the data it has been selected to broadcast by certain multi-hop neighbors. For example, as shown in FIG. 15, device R may broadcast its H1(R), and H1(Z), but it may not broadcast H2(R), H3(R), H4(R), etc. An advantage to limiting the broadcast of all known multi-hop neighbors is saving data transmission and power consumption.

In other embodiments, a device may further limit the data that it broadcasts in a multi-cast message. For example, the device R may only multi-cast a small amount of data indicating whether it has any newly discovered one-hop or multi-hop neighbors, without specifying the nature of those newly discovered neighbors. This data may be broadcast during an advertising state, as described with reference to FIG. 6, at Blocks 605-607. Then, the device Q, which is within one-hop range of the multicast, may receive this limited information during its own scanning state, as described with reference to FIG. 6, at block 610. Then, Q may send a response request (Block 611). R may then uni-cast the response data to Q (Block 612). This response data can include, for example, new information H1(Z),

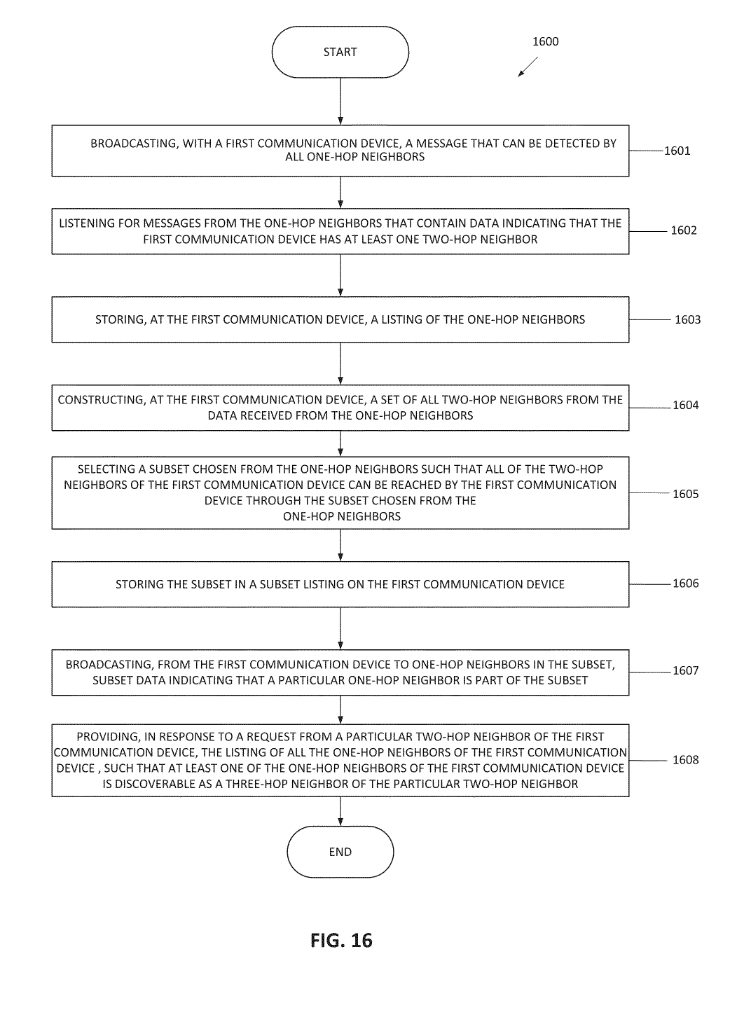

Referring back to FIG. 2A, and simultaneously referring to FIG. 16, which is a flowchart depicting steps 1600 which may be traversed by the embodiment depicted in FIG. 2A. As shown in this embodiment, the advertising component 256 of a first communication device can broadcast a message that can be detected by all one-hop neighbors (Block 1601). The scanning component 258 can listen for messages from the one-hop neighbors that contain data indicating that the first communication device has at least one two-hop neighbor (Block 1602). Then, the list storage component 262 can store a list of the one-hop neighbors (Block 1603), construct a set of all two-hop neighbors from the data received from the one-hop neighbors (Block 1604), select a subset chosen from the one-hop neighbors such that all of the two-hop neighbors can be reached through the subset of one-hop neighbors (Block 1605), and store the subset (Block 1606). Then, the advertising component 256 can broadcast the subset data indicating that a particular one-hop neighbor is part of the subset (Block 1607). Finally, the advertising component 256 can provide, in response to a request received via the scanning component 258 from a particular two-hop neighbor, the listing of all the one-hop neighbors of the first communication device, such that at least one of the one-hop neighbors of the first communication device is discoverable as a three-hop neighbor of the particular two-hop neighbor (Block 1608).

The various illustrative logical blocks, modules, and circuits described in connection with the embodiments disclosed herein (e.g., the advertising component 256, the scanning component 258, the probability calculator 260, and the list storage component 262) may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for discovering neighbors of communication devices, wherein the neighbors are also communication devices, the method comprising:
broadcasting, at a first communication device, a message that can be detected by all one-hop neighbors of the first communication device;
wherein the one-hop neighbors are neighbors within a physical wireless transmission range of each other;
listening, at the first communication device, for messages from one-hop neighbors containing data indicating that the first communication device has at least one two-hop neighbor;
wherein a two-hop neighbor shares a common one-hop neighbor;
storing, at the first communication device, a listing of the one-hop neighbors;
constructing, at the first communication device, a set of two-hop neighbors from the data received from the one-hop neighbors;
selecting a subset of the one-hop neighbors such that all of the two-hop neighbors can be reached through one or more of the subset of the one-hop neighbors;
storing the selected subset in a subset listing on the first communication device;
broadcasting, from the first communication device to all of the one-hop neighbors in the subset, subset data indicating that a particular one-hop neighbor is part of the subset;
providing, in response to a request from a particular two-hop neighbor of the first communication device, the listing of all the one-hop neighbors of the first communication device, such that at least one of the one-hop neighbors is discoverable as a three-hop neighbor of the particular two-hop neighbor.

2. The method of claim 1, further comprising:
listening for messages from one-hop neighbors containing data indicating that the first communication device has at least one (n−1)-hop neighbor and at least one n-hop neighbor, wherein n is greater than 3 and n-hop neighbors are linked through (n−1) one-hop neighbors situated between the n-hop neighbors;
storing, at the first communication device, a listing of (n−1)-hop neighbors;
constructing, at the first communication device, a set of all (n−1)-hop neighbors from the data received from all one-hop neighbors;
selecting a subset chosen from the set of (n−1)-hop neighbors such that all of the n-hop neighbors of the first communication device can be reached by the first communication device through one or more of the subset of (n−1)-hop neighbors;
storing the subset chosen from the (n−1)-hop neighbors on a list on the first communication device;
broadcasting, from the first communication device, the data indicating that a particular (n−1)-hop neighbor is part of the subset to (n−1)-hop neighbors in the subset; and
providing, in response to a request from an n-hop neighbor of the first communication device, the set of all one-hop neighbors of the first communication device, such that any one-hop neighbor of the first communication device is discoverable as an (n+1) hop neighbor of any other n-hop neighbor of the first communication device.

3. The method of claim 1, wherein;
the subset of one-hop neighbors selected by the first communication device is a smallest subset of one-hop neighbors that can reach all of the two-hop neighbors.

4. The method of claim 1, further comprising;
running, at any of the communication devices, discovery protocols including states of advertising, scanning, and sleeping;
broadcasting messages, at any of the communication devices, during an advertising state;
receiving messages, at any of the communication devices, during a scanning state and;
running, at any of the communication devices, the discovery protocols asynchronously.

5. The method of claim 4, wherein;
the states of advertising, scanning and sleeping of any of the communications devices are determined by a dominant parameter,
wherein a dominant parameter is derived from an algorithm and associated with a percentage, and indicates that it is preferable for a device to exist in one of the states rather than other states at a particular time

6. The method of claim 5, wherein;
the dominant parameter is derived from data including data received from other devices and from a user.

7. A system for discovering neighbors of communication devices, wherein neighbors are also communication devices, and wherein one-hop neighbors are neighbors within physical wireless transmission range of each other, and wherein n-hop neighbors are neighbors linked by (n−1) one-hop neighbors situated between the n-hop neighbors, the system comprising;
a plurality of communication devices in a peer-to-peer network arranged such that all devices are within n+1 hops from each other,
wherein n+1 is the largest number of hops between any two of the communication devices
a first communication device within the plurality of communications devices;
at least one one-hop neighbor of the first communication device;
at least one two-hop neighbor of the first communication device;
wherein at least two of the communication devices are three hops away from each other;
wherein each of the communication devices runs a discovery protocol that is asynchronous with at least one other of the communication devices that is running the discovery protocol; and
wherein each of the communication devices comprises a list storage component for storing data about its neighbors and an advertising component that broadcasts the stored data about its neighbors that allows a communication device that is n-hops away from the first communication device to discover at least one communication device that is n+1 hops away.

8. The system of claim 7, wherein;
the discovery protocol consists of states of advertising, scanning, and sleeping.

9. The system of claim 8, wherein;
any of the communication devices can broadcast data during an advertising state and any communication device can detect data broadcast by its one-hop neighbors during its scanning state.

10. The system of claim 9, wherein;
the broadcast data includes a list of the one-hop neighbors of a multi-hop neighbor.

11. The system of claim 8, wherein;
the advertising, scanning, and sleeping states of the discovery protocol are determined by a dominant parameter,
wherein a dominant parameter is derived from an algorithm and associated with a percentage, and indicates that it is preferable for a device to exist in one of the states rather than other states at a particular time

12. The system of claim 11, wherein the dominant parameters are default parameters.

13. The system of claim 12, wherein;
the dominant parameters are calculated based on data from default algorithms and one or more of the following: data from other devices, data about a device's power source, and user input data.

14. A non-transitory, tangible computer readable storage medium, encoded with processor readable instructions to perform a method for discovering neighbors of communication devices, wherein neighbors are also communication devices, the method comprising:
broadcasting, at a first communication device, a message that can be detected by all one-hop neighbors of the first communication device,
wherein the one-hop neighbors are neighbors within a physical wireless transmission range of each other;
listening for messages from the one-hop neighbors that contain data indicating that the first communication device has at least one two-hop neighbor,
wherein two-hop neighbors shares a common one-hop neighbor;
storing, at the first communication device, a listing of the one-hop neighbors;
constructing, at the first communication device, a set of all two-hop neighbors from the data received from the one-hop neighbors;
selecting a subset chosen from the one-hop neighbors such that all of the two-hop neighbors can be reached through one or more of the subset of the one-hop neighbors;
storing the subset in a subset listing on the first communication device;
broadcasting, from the first communication device to one-hop neighbors in the subset, subset data indicating that a particular one-hop neighbor is part of the subset;
providing, in response to a request from a particular two-hop neighbor of the first communication device, the listing of all the one-hop neighbors of the first communication device, such that at least one of the one-hop neighbors is discoverable as a three-hop neighbor of the particular two-hop neighbor.

15. The non-transitory, tangible computer readable storage medium of claim 14, wherein the method includes:
listening for messages from one-hop neighbors that contain data indicating that the first communication device has at least one (n−1)-hop neighbor and at least one n-hop neighbor, wherein n is greater than 3 and n-hop neighbors are linked by (n−1) one-hop neighbors situated between the n-hop neighbors;
storing, at the first communication device, a listing of (n−1)-hop neighbors;
constructing, at the first communication device, a set of all (n−1)-hop neighbors from the data received from all one-hop neighbors;
selecting a subset chosen from the set of (n−1)-hop neighbors such that all of the n-hop neighbors of the first communication device can be reached by the first communication device through one or more of the subset of (n−1)-hop neighbors;
storing the subset chosen from the (n−1)-hop neighbors on a list on the first communication device;
broadcasting, from the first communication device, the data indicating that a particular (n−1)-hop neighbor is part of the subset to (n−1)-hop neighbors in the subset; and
providing, in response to a request from an n-hop neighbor of the first communication device, the set of all one-hop neighbors of the first communication device, such that any one-hop neighbor of the first communication device is discoverable as an (n+1) hop neighbor of any other n-hop neighbor of the first communication device.

16. The non-transitory, tangible computer readable storage medium of claim 14, wherein:
the subset of one-hop neighbors that is selected by the first communication device is a smallest subset of one-hop neighbors that can reach all of the two-hop neighbors of the first communication device.

17. The non-transitory, tangible computer readable storage medium of claim 14, wherein the method includes:
running, by any of the communication devices, discovery protocols consisting of states of advertising, scanning, and sleeping;
broadcasting messages, by any of the communication devices, during an advertising state;
receiving messages, by any of the communication devices, during an scanning state and;
running, by any of the communication devices, the discovery protocols asynchronously.

18. The non-transitory, tangible computer readable storage medium of claim 17, wherein the method includes:
the states of advertising, scanning and sleeping of any of the communications devices are determined by a dominant parameter,
wherein a dominant parameter is derived from an algorithm and associated with a percentage, and indicates that it is preferable for a device to exist in one of the states rather than other states at a particular time

19. The non-transitory, tangible computer readable storage medium of claim 18, wherein the method includes:
a dominant parameter is derived from data including data received from other devices and from a user.
